(19) United States
(12) Patent Application Publication
(10) Pub. No.: US 2004/0128016 A1
(43) Pub. Date: Jul. 1, 2004

(54) Method for manufacturing a near net-shape mold

(76) Inventor: David H. Stewart, Houston, TX (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/221,964

(22) PCT Filed: Mar. 22, 2001
(86) PCT No.: PCT/US01/08971

(51) Int. Cl. G06F 19/00

(52) U.S. Cl. 700/159

(57) ABSTRACT

A method for manufacturing a near net-shape mold from a weldable material, including creating a computer model of a mold portion (30,32), analytically sectioning the computer model of the mold portion into a plurality of mold zones (22), generating mold zone cutting paths for a cutting machine to follow, cutting the weldable material into plurality of mold zones, generating surface profile cutting paths for a cutting machine to follow, machining surface profiles into the mold zones, assembling the mold zones by placing the mold zones side-by-side, generating welding paths for an electron beam welding a machine to follow, and welding the mold zones together.

### BACKGROUND OF THE INVENTION

1. Field of the Invention

The present invention relates to mold manufacturing. Specifically, the present invention relates to a process for manufacturing near net-shape molds by individually machining and subsequently joining mold segments together.

2. Description of the Related Art

An examination of the techniques used to produce molding tools, or molds, will prove useful in demonstrating the benefits of the inventive process. Currently, the manufacturing of molds for use in the automotive, consumer products, appliance, computer, and consumer electronics industries is a tedious process involving numerous steps and long lead times. A few examples of parts that require molds are:

automobile parts such as SMC or SRIM body or structural panels, and injection molded parts such as bumper covers, intake manifolds, dash trim, etc.;

consumer products such as trash cans, laundry baskets, buckets, storage containers, etc.;

appliances such as vacuum cleaners, washing machines, and dishwashers;

computer cases for laptops, desktops, and servers; and

consumer electronics enclosures for radios, televisions, etc.

The molds for these parts can cost from $40,000 for a simple, low volume mold to over $1,000,000 for a very large Class A automotive mold capable of producing more than 1 million parts.

After the part and the mold are designed, there are two conventional ways to begin the manufacture of a large mold. If the part to be molded is not too deep and has primarily flat contours, the mold can be cut out of a solid block of tool steel. If the part to be molded is very large and has deep contours, a tool steel casting to a near net-shape can be made and then machined. In both cases, the contours of the mold are rough cut out of hardened (usually R_{c} 30-40) tool steel, which is a slow and expensive process requiring very large and powerful machining centers that can cost hundreds of thousands or even millions of dollars. Although a casting is delivered closer to the final mold shape, the exact as-cast surface is not known, so the first cuts must be slow and careful to avoid crashing the cutting tool into the cast surface. With a solid block, cuts can be made with confidence, but a larger volume of material must be removed. In both cases, getting from the part design to the fully roughed surface comprises a large portion of the manufacturing time. The lead time on a casting for a large automotive mold can consume half of the production time, and roughing another 20%. For injection molds where it is feasible to cut the cavity and core out of solid blocks, roughing can consume from 30-70% of the total time, depending on the amount of material that must be removed and the finish required.

After roughing is completed, finish machining begins. For many large molds, roughing and finishing are done on separate equipment because of the radically different requirements for stiffness, power, and accuracy. Machines that efficiently perform both operations are extremely expensive. The most commonly employed method for finishing large molds uses ball end mills and very small step-over heights in the cutter path. This is a slow process because the number of passes required is very high and the machine feeds must be kept low to ensure dimensional accuracy. Finishing in this manner can consume up to 30% of the lead time. Electrical discharge machining (EDM) is an alternate process that has proved very successful in finishing and even polishing of molds, but is not usually any faster than machining when applied to very large molds.

The next step in the production of the mold is benching, or the grinding and polishing stage. Even using modern methods, this is a very labor intensive process that can take from 15-20% of the lead time, depending on the surface finish requirements and finish machining quality. A mold that has been EDM finished usually requires significantly less bench work.

The final step is the assembly of the mold and machining for all of the ancillary bushings, pins, and other mold features. A difficult process is the gun-drilling of the cooling or heating lines into the mold. Because the length-to-diameter ratio of these lines can be 100 or more in a large mold, special care must be taken to support the shank of the drill with bushing inserts as the holes are cut. This increases the cost of the process considerably. A reasonable amount of accuracy is also required to ensure that the mold remains dimensionally stable under pressure and has adequate heat transfer characteristics. In a cast mold, heating/cooling channels can sometimes be cast in place, but they have to be deflashed internally and their position relative to the mold surface is not known precisely.

Conventional machining has reached the limits of its potential for large mold manufacture. The difficulties that prevent further improvements with these techniques are that:

lead times for castings are very long;

material can be removed from hardened steels only at a limited rate, resulting in long roughing cycles;

very slow feed rates are required during finish passes in order to maintain dimensional accuracies;

low spindle speeds and slow feed rates are required to maintain the quality of ball end mill cuts; and

cooling lines are limited to straight paths and are difficult to drill.

Newer techniques are now being adopted that provide significant improvements over older technology. Advance machining and nickel shell tools are the two most successful methods for speeding the production of large mold, but a wide variety of rapid tooling technologies have also made an impact on the market for smaller parts. These processes are described below.

One advance in machining since the introduction of computer numerical control (CNC) is the introduction of High Velocity Machines (HVM). High velocity machines have transformed the way in which large molds may be manufactured.

For comparison purposes, conventional machining centers operate at spindle speeds of 200-6000 rpm and at feed rates of 1-4 m/min. These older CNC systems often limit the feeds to less than 1 m/min when complex surfaces requiring high accuracy are cut. Moreover, these massive machines are also slow to change directions, usually accelerating at a rate of 0.1 g or less. A typical procedure for cutting a large mold from a block of steel is as follows:

slab 10 mm of material off the surface of the block, then reset the tool on the machined surface;

rough out a 2-dimensional mold cavity approximating the final geometry using a 100 mm face mill;

continue roughing out the contours of the mold cavity with a 50 mm ballnose end mill, with cuts up to 25 mm deep at feeds of up to 2 m/min with a 10 mm step-over;

complete roughing of the mold contours with 25, 20, and 10 mm end mills at feeds of up to 3 m/min;

move the rough cut mold to a finishing machine with a lower power, faster spindle having higher accuracy;

finish cut the mold contours with 10, 6, and 4 mm end mills at feeds usually below 3 m/min and step-overs as small as 0.2 mm, resulting in cusp heights of between 0.04-0.01 mm; and

grind and polish the mold contours, anywhere from 50 to 400 hours depending on finish requirements.

In a high velocity machine (HVM), the machine components and electronics are capable of much higher performance than in previous systems. The key component of a HVM is its spindle. Operating at speeds from 10,000 to 60,000 rpm, these devices rely on ceramic, hydrodynamic, or magnetic bearings to allow cutting tool speeds far above those used in conventional machining. To take advantage of these high speeds, the machine must be capable of accurately maintaining a much faster feed rate. Precision ball screws or linear motors, combined with lighter, computer optimized castings for the structure, allow high speeds while a new generation of CNC controls increases block processing speed to ensure positional accuracy. The resulting HVM provides material removal rates twice as high as conventional systems, with better accuracy and finish quality. Even at such high speeds, all cuts can be of finish quality. Moreover, the feed rates possible with smaller end mills can go from 3 m/min to 30 m/min at accelerations of up to 3 g, thereby significantly reducing finish machining time. Additionally, smaller step-overs can be used, resulting in cusp heights below 0.005 mm, which can dramatically reduce or even eliminate benchwork.

Unfortunately, HVM's are currently very large and expensive, costing as much as 10 times more than a conventional machine. Although this large, up-front, capital requirement has prevented most of the smaller tool and die shops from adopting this technology, the automotive industry has already realized tremendous gains in lead times and productivity using HVM. Smaller shops that have taken the leap into HVM may struggle with the technical differences from conventional machining, but they almost always report substantial cost savings and lead time reductions after an adjustment period.

Nickel Vapor Deposition (NVD) is a fast alternative manufacturing process to conventional electroforming of nickel shells for molds. NVD uses a chemical reaction between nickel and carbon monoxide to deposit nickel atom by atom onto a pattern. The process deposits 99.998% pure nickel with feature resolution on the nanometer level at a rate of 0.25 mm/hr. At this rapid rate, nickel shells with a wall thickness of 6 mm can be produced in 24 hours.

The NVD process starts with the development of the pattern. The pattern can be machined from a variety of materials depending on the ultimate use for the finished mold, but is typically constructed out of a non-porous metal. For fast deposition the pattern is heated to between 175 and 180° C. At these elevated temperatures, expansion of the mold must be taken into consideration for high accuracy shells. Cast or 6061 plate aluminum are the most common metallic pattern materials used, though zinc, stainless steel, copper, and brass have also been used successfully. Wood, plastic, and other materials are suitable for lower temperature (slower) NVD. These patterns are coated with a conductive coating before deposition. Because the nickel deposits one atom at a time, surface features on these patterns are reproduced exactly, so that a wood grain is easily reproduced if desired.

After the pattern is formed, it must be carefully cleaned in a clean room to prevent flaws in the surface. The pattern is then placed in a low-pressure chamber for deposition. The nickel vapor is fed to the low-pressure chamber and deposits on the surface of the pattern. Deposition thickness commonly ranges from about 4 mm to 6 mm with possible deposition thickness between a fraction of a millimeter and over 35 mm. When the desired thickness has been deposited the shell is removed from the pattern in a non-destructive process which enables the pattern to be cleaned and re-used. The nickel shell is then ready to be placed into a mold backing. The shell itself can be machined, polished, welded, and generally treated in the same way most mold surfaces are handled.

Because the NVD process uses a low-pressure chamber for deposition, this chamber defines the maximum dimensions of the part. Very large chambers are commercially available, and patterns as large as 1.2 m by 2.5 m are common. The accuracy of the shell depends on the size of the pattern, but is typically on the order of 0.15 to 0.25 mm. Of course, tolerances also depend on any finishing of the shell after it has been placed in the mold backing. As with nickel shells produced by other methods, the NVD shell has excellent properties. It is more durable than steel, is corrosion resistant, and has excellent dimensional stability. Additionally, the process leaves no residual stresses in the shell and produces a uniform shell thickness with any desired surface texture as defined by the pattern. Nickel shells are repairable, and with the NVD process multiple shells can be created in a matter of days.

Another newer tooling process uses a composite mold construction coupled with conformal cooling in an effort to reduce cycle times, cut molding costs and improve thermal properties, such as heat transfer, in injection molds. This process starts with 3-dimensional computer-aided design (CAD) models of the part and the mold inserts, and then CNC machines a pattern from an easy-to-cut material. The pattern is made electrically conductive by coating it with silver paint, and then electroforming it with about 2 mm of nickel. Cooling channels conforming to the part's geometry are designed and created while the nickel shell is being electroformed, and are then positioned on the back of the nickel shell. Then the pattern, nickel shell, and contoured cooling assembly are placed in a second electroforming vat for a coating of copper. This layer is typically 4 to 6 mm thick and encapsulates the cooling channels.

The entire nickel/copper assembly is then usually backed with a proprietary composite featuring a high compression strength to form a mold shell. The coefficients of thermal expansion (CTE) of all three materials are closely matched to prevent delamination of the mold shell. Ejector holes and pins, cooling inlet and outlet connections, and, if need be, texturing and other conventional features are readily included. The mold shell is then assembled into a standard mold base for production.

This process produces a mold with a reasonably hard, very accurate nickel surface and a highly conductive copper backing. The cooling channels not only conform to the surface of the mold for more even cooling, but are also designed with greater surface area than circular channels and have features to induce turbulence to increase heat transfer rates to the coolant. Because the injected material can cool more quickly and much more evenly in the mold, finished parts have reduced internal stresses and warping. Also, cycle times for the molded parts can be as much as 75% lower than with conventionally produced molds, with a 20%-30% reduction expected to be common. More parts molded per minute means an increase of output without the purchase of additional machines.

One drawback of this process is that the finished mold may not have the same life as a comparable steel mold. The nickel shell layer can be replaced or repaired using electroforming or welding, however, and tests on the molds have shown the molds to be good for at least 270,000 parts. The drawback is that rework of the shell can take 4-5 weeks if it becomes necessary. Also, the resulting mold has a maximum mold temperature of between 190 and 204° C. (375 to 400° F.) and a maximum injection pressure between 70 and 100 MPa. At present the accuracy of the molds is comparable to that of CNC produced molds. These molds should be cost competitive with standard molds and have an 8-10 week manufacture time (much of which is due to the lengthy electroforming process), but promise substantial savings in reduced cycle time.

There are also a wide variety of other new tooling technologies that aim to produce molds with much shorter lead times than conventional machining. Virtually all of these are based on some type of rapid prototyping (RP) technique such as stereo lithography or powder metal sintering, and many have the capability to form conformal cooling channels into the mold. The goal of each of these processes is to shorten lead times by going directly from a CAD model to a finished mold, eliminating machining and most bench work. Some of the leading techniques are:

Rapid Solidification Process (RSP)—This process uses hot inert gas to atomize a liquid tooling metal. The droplets are sprayed on a substrate, layer after layer, to generate the final part.

Resin Binder Process—This process uses an ink-jet printer based technique that deposits a resin binder over a layer of tool steel powder. The resulting ‘green’ part is sintered, the binder burned away, and then infiltrated with a second metal to form a fully dense part.

Tungsten Carbide/Steel Process—This process uses stereo lithography machines to build a RP model of a part, which is used as a pattern for a silicone rubber mold. A mixture of tool steel, tungsten carbide, and binder is then poured into the mold. Sintering and infiltration follows.

Selective Sintering Process—This process uses a CO₂ laser to sinter a polymer bound tool steel powder part, then also follows with infiltration.

Epoxy Steel—This process also begins with a RP pattern, but casts a part that is composed of a mixture of 90% steel and 10% epoxy. The material is claimed to resist high temperatures and have higher compression strength than aluminum.

Laser Engineered Net Shaping (LENS)— This process focuses a high powered laser onto a substrate where metal powders are injected under computer control to form a fully dense, near net shape part, layer by layer.

On the plus side, each of these processes has the ability to form conformal cooling channels, and RSP and LENS have the potential to combine hard tool steel and high conductivity copper in the same part, tapering the concentration gradually in an interface zone. Some of these techniques also allow integration of sensors into the interior of a mold. Most importantly, the lead time over conventional machining tends to be much shorter.

On the negative side, while these processes promise large advantages for smaller parts, none of them can be applied to larger molds. The rapid prototyping (RP) and sintering processes have an inherent random error and shrinkage component that prevents accuracies better than 0.1% across a mold. In a 25 cm part dimension, this Would result in an error of 0.25 mm, 5-10 times the limits typically specified in a machined mold. If finish machining is required on these molds, their cost and lead time advantages tend to disappear. Additionally, the cost per kilogram of the rapid tooling materials tends to be much higher than cast or block steel, making these processes much more expensive for large molds.

Thus, even with the recent development of these rapid tooling technologies, manufacturers of large molds have seen improvements in cost and lead time only by employing HVM or nickel shells. The success of these processes in the smaller mold market underlines the tremendous value to be gained by reducing lead time and cycle time.

The present inventive process is a manufacturing process for molds that is expected to cut lead time in half, especially for large molds, and provide improved part quality and shorter cycle times by allowing mold features that are unavailable with current techniques. The inventive process is expected to improve current practices through one or more of the following advances to mold manufacture, the molding process, and the tool and die industry:

Reduction or elimination of casting and rough machining operations

Benefits: drastic reductions in lead times

increased productivity of existing machining centers

reduced part handling and labor costs

Addition of heating/cooling lines that conform to part geometry

Benefits: faster cycle times

smaller temperature fluctuations

increased productivity of molding equipment

decreased warpage and residual stresses

Increased competitiveness and productivity of the tool and die industry

Benefit: lead time reductions and cost savings to customers

The current invention improves on the state of the art of mold manufacturing by, among other things, providing a substantial reduction in mold manufacturing times and cost, and providing for improved quality.

### SUMMARY OF SOME OF THE ASPECTS OF THE INVENTION

The advantages and purposes of the invention will be set forth in part in the description which follows, and in part will be obvious from the description, or may be learned by practice of the invention.

To attain the advantages and in accordance with the purpose of the invention, as embodied and broadly described herein, the method for manufacturing a near net-shape part from a plate material, in a first aspect, includes the steps of cutting, machining, assembling, and welding. The step of cutting includes cutting the plate material into a plurality of zones, each zone having a length, a width, and a depth. The step of machining includes machining a surface profile into the depth and across the width of at least one of the plurality of zones. The step of assembling includes assembling the plurality of zones by placing the zones side-by-side. And, the step of welding includes welding the plurality of zones together.

In a second aspect, the method for manufacturing a near net-shape part from a plate material includes the steps of creating, analytically sectioning, generating, cutting, generating, machining, assembling, generating, and welding. The step of creating includes creating a computer model of a mold portion. The step of analytically sectioning includes analytically sectioning the computer model of the mold portion into model zones. The first step of generating includes generating the mold zone cutting paths for a cutting machine to follow. The step of cutting includes cutting the plate material into a plurality of mold zones, each mold zone having a length, a width, and a depth. The second step of generating includes generating the surface profile cutting paths for the cutting machine to follow. The step of machining includes machining a surface profile into the depth and across the width of at least one of the plurality of mold zones. The step of assembling includes assembling the plurality of mold zones by placing the mold zones side-by-side. The third step of generating includes generating the welding paths for a welding machine to follow. And, the step of welding includes welding the plurality of mold zones together.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 illustrates an exemplary injection mold core for a bumper cover as could be manufactured according to the present invention.

FIG. 2 shows a computer depiction of lower and upper mold halves as could be manufactured by the present invention.

FIG. 3 shows a model of the mold as could be manufactured by the present invention.

FIG. 4 shows the model of FIG. 3 sectioned into zones.

FIGS. 5A-5C show the manufacturing progression of a selected zone of FIG. 4.

FIG. 6 schematic illustrates a mold backing as could be manufactured by the present invention.

FIG. 7 schematically depicts the jet lag of a waterjet cutter.

FIG. 8 schematically illustrates an electron beam welding machine and a gun.

FIG. 9 schematically illustrates a keyhole weld.

FIG. 10 schematically depicts the diffusion brazing process.

FIG. 11 schematically depicts a zone composed of subzones of different materials.

FIG. 12 shows a typical flowchart for the process.

### DETAILED DESCRIPTION OF THE EMBODIMENTS

Reference will now be made in detail to the present exemplary embodiments of the invention, which are illustrated in the accompanying drawings. Wherever possible, the same reference numbers will be used throughout the drawings to refer to the same or like parts.

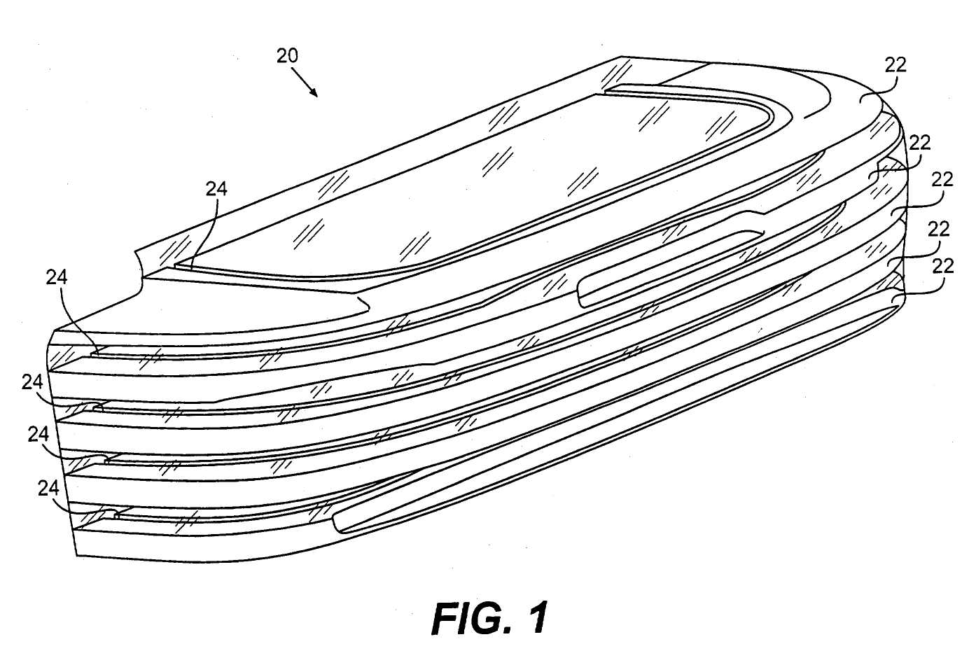

It is anticipated that the inventive process will substantially cut the lead times for manufacturing molds or mold portions, especially large molds but also for medium-sized molds or any mold with a complex geometry, while also providing improved part quality and shorter cycle times by allowing mold features that are unavailable with current techniques. The process could deliver a near net-shape mold or mold portion, ready for finish machining, to the mold maker in a fraction of the time it takes to cast or rough a mold cavity, providing a potential savings of materials and time. In one embodiment, the invention also could allow the incorporation of conformal heating/cooling lines. Such conformal heating/cooling lines could reduce the cycle time for large molded parts by an estimated 20-75% thereby reducing manufacturing costs. FIG. 1 illustrates a proposed injection mold core (20) for a bumper cover with half of each zone section (22) rendered transparent to show the internal heating/cooling channels (24).

In one embodiment, the inventive process leverages three primary state-of-the-art technologies: 5-axis abrasive waterjet cutting, electron beam welding (EBW), and knowledge based computer aided design (CAD) to assemble a near net-shaped mold or mold portion out of relatively thin sections, or zones, of metal plate. For instance, the relatively thin zones of metal plate could be formed from ground tool steel plates, which could be cut with a 5-axis abrasive waterjet. These mold portion zones could have complex heating and/or cooling channels formed into them, which could follow the contours of the mold, thereby allowing improved temperature uniformity and heat transfer in the finished mold. The zones could be assembled and fixtured in an Electron Beam Weld (EBW) chamber where they could be welded, for instance at penetration depths up to 100 mm. The heating and/or cooling channels could be deflashed with, for example, Abrasive Flow Machining (AFM) and the mold then shipped to the customer for finish machining and polishing.

Casting a near net-shape mold can reduce the amount of material that must be removed in the machining process, but the need to build a pattern and optimize the pour for a fully densified casting nullifies any great lead time advantages, and is cost effective on only the largest of tools with the deepest contours. The inventive process seeks to provide a near net-shape mold similar to a casting that can be finish machined into the final mold, without the long lead time and limited accuracy that are characteristics of castings.

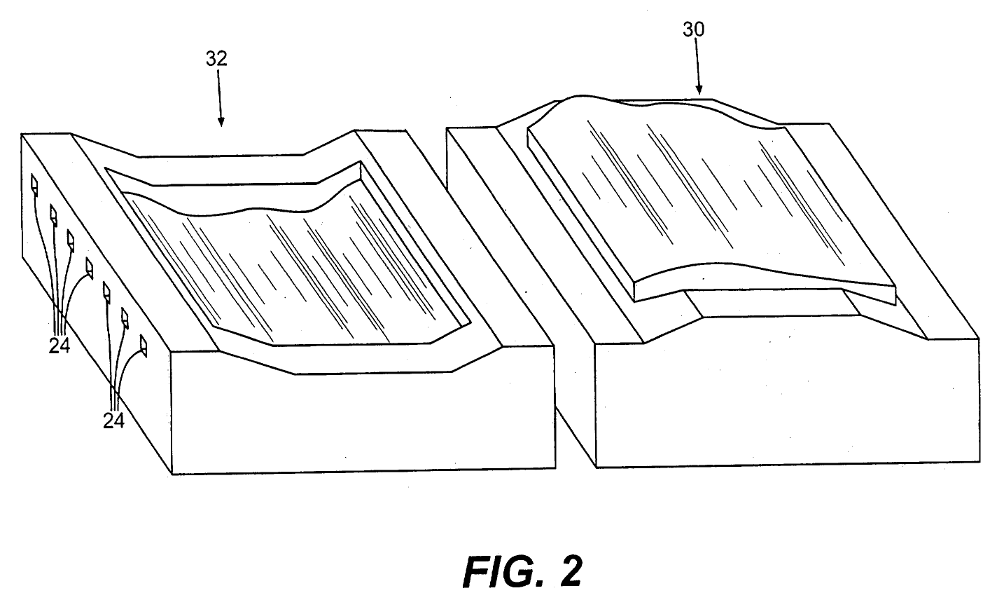

In one embodiment, the inventive process begins with a model of the part to be molded. Preferably the model is a computer model. The model may be created by the manufacturer and transmitted to the tooling company in the normal fashion. Traditionally, the tooling company would design the mold geometry and parting lines, and locate the position of the gun-drilled heating/cooling channels. A solid model of the core mold half (30) and the cavity mold half (32), for example as shown in FIG. 2, could be created and checked for interference. Again, preferably, this model is a computer model. An analysis of the mold filling process could also be performed to predict mold performance. In a preferred embodiment, this analysis would be a numerical analysis performed by a computer. In another embodiment, a CNC milling program could be developed to perform the roughing and finishing operations on the mold material, for instance, a block of tool steel.

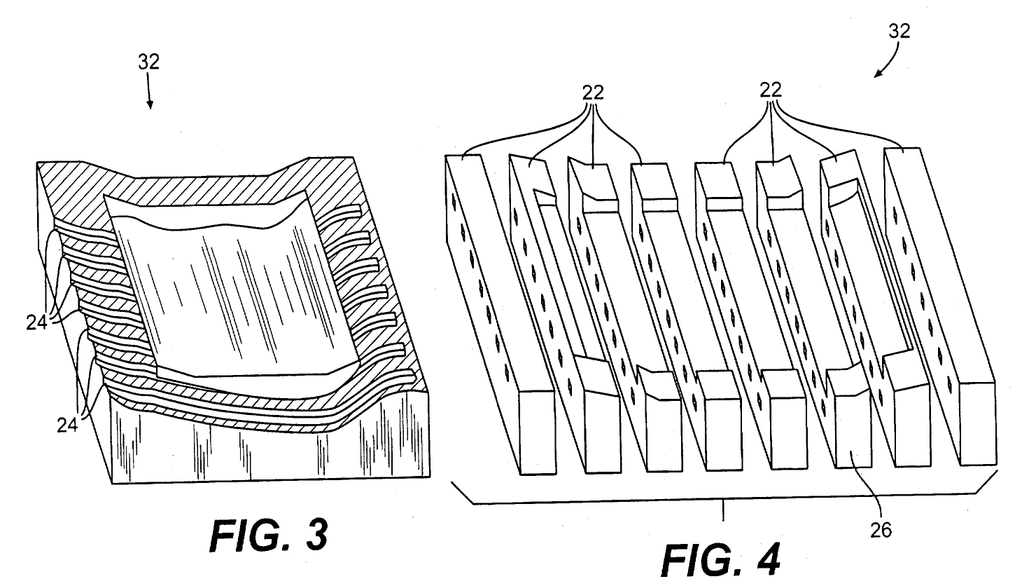

In the design cycle of one embodiment of the current inventive process, one difference from the conventional mold manufacturing processes could be in determining the location of the heating and/or cooling channels. These heating and/or cooling channels (24) (shown in a semi-transparent model in FIG. 3) could be added as a feature in the mold model. Interactive software tools coupled with non-linear heat transfer analysis could be used to determine the optimal location and geometry of the heating and/or cooling channels (24), ensuring the proper heat transfer and structural properties in the final mold.

Conformal heating and/or cooling channels could be added in at least two ways. Channels could be cut through the plate sections with a waterjet cutter and linked together to form the final channel, or the channels could be machined into or across the face of the appropriate zone section. Either way, it is expected that variation in temperature across the surface of the mold could be greatly reduced, thereby improving the quality of the molded part by minimizing residual stresses.

In one embodiment, heat transfer could be accomplished by a method of pulsed cooling. Pulsed cooling differs from conventional continuous cooling by changing and controlling the flow of coolant in the mold. Flow control could be based, for example, on temperature sensor readings. Instead of attempting to keep the mold at a fixed temperature, the mold could be allowed to heat up during the fill cycle, and then utilizing chilled coolant to rapidly bring the mold to the de-mold temperature. The increased efficiency of pulsed cooling relies on the principle that the rate of heat transfer is proportional to the temperature difference. By allowing the mold to heat during fill and using colder coolant, it its expected that the temperature difference could be three times greater than normal cooling.

In one embodiment, pulsed cooling could operate as follows. First, shut off coolant flow during mold fill to allow hot resin to flow freely in the mold while also increasing the temperature of the mold. This would result in faster fill times because a warmer mold provides less resistance to resin flow. Second, pulse coolant through the mold after the fill finishes, thereby rapidly cooling the mold and the part. This would result in faster cooling because the sudden influx of significantly colder coolant increases heat transfer and reduces cooling cycle time. Other benefits of pulsed cooling could include reduced stresses in the finished part, reduced warpage of the finished part, and increased finished part quality. Pulsed cooling could also allow the outer mold surface to warm up as part of the mold cycle, thereby reducing the chance of condensation forming on the mold surface.

Conformal cooling benefits are additive with pulsed cooling benefits, thereby allowing even shorter cycle times. Furthermore, the design of the conformal cooling channels and internal structure of the mold may be optimized to take advantage of the pulsed cooling technique and increase the efficiency of the pulsed cooling. By eliminating unnecessary material from the mold interior (with, for instance, the aid of finite element analysis) the total heat capacity of the mold may be reduced. This would allow faster overall heating or cooling of the mold, making it easier to raise and lower the temperature of the mold quickly. In one embodiment, the mold could be intentionally heated before injection of the resin flow, providing even further benefits during the fill cycle. With a hofter melt, thinner parts could be molded and the appearance of weld lines could be significantly reduced. In another embodiment of the present invention, a dynamic heat transfer analysis of the tool could be used in conjunction with a structural finite element analysis to allow the design of an optimized mold for pulsed cooling. In even another embodiment of the invention, the method of making near net-shaped molds could improve on the benefits of pulsed cooling by allowing the mold to be heated before resin injection, thereby increasing the melt flow rate and providing an even higher heat transfer rate when the coolant is pulsed to bring the mold to the de-mold temperature.

According to one embodiment of the invention, when the geometry of the mold has been finalized, it is then analytically sectioned into zones (22). The optimal number and width of the zones (22) could depend on the part geometry, available tooling plate thicknesses, and the size of the mold. FIG. 4 shows the lower mold half (32) of FIG. 3 after analytical sectioning it into zones (22).

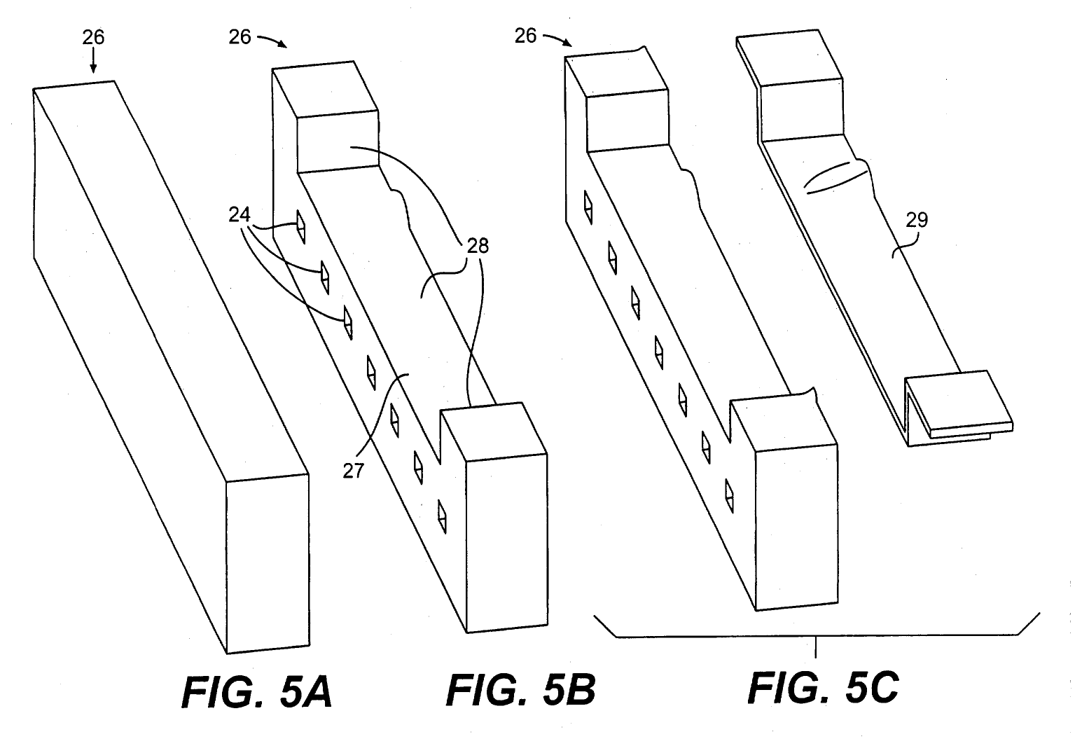

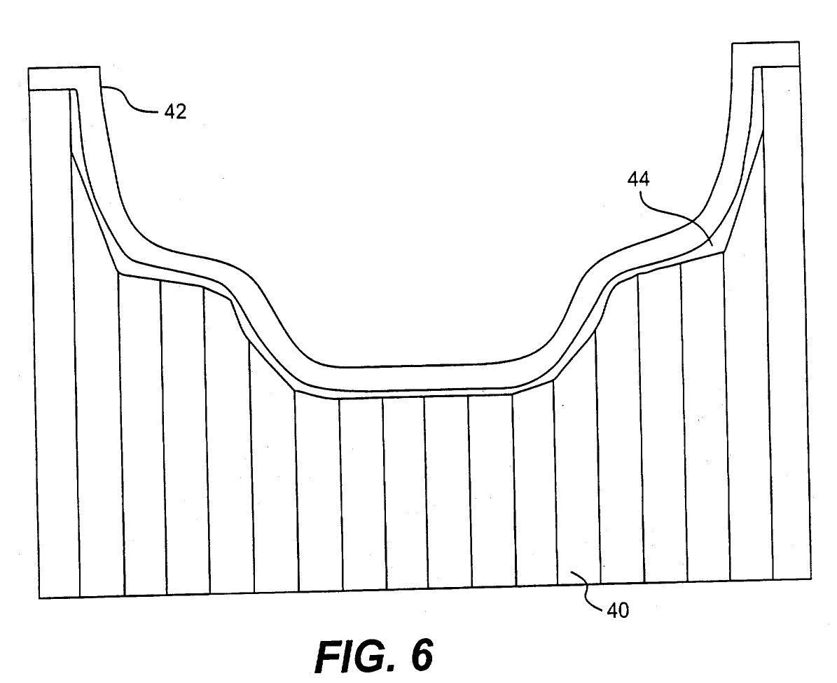

In a preferred embodiment, the next step in the process is the generation of the cutting paths for a 5-axis abrasive waterjet cutter so that near net versions of the zones (22) may be sliced out of the appropriate thickness of the tooling plate material, for instance ground tool steel plate. One zone, zone (26), from FIG. 4 will be used as an example. First, a rectangular envelope for zone (26) is established, preferably using a computer model, and used as a basis for machining, as shown in FIG. 5A. An offset surface (27) of the final mold geometry may be analytically created to ensure that a safe amount of material for final machining remains, as shown in FIG. 5B. Using, for example, a 5-axis machining program constrained by a knowledge base of a waterjet's capabilities, a path for the cutter could be analytically generated such that the cutter would slice the tooling plate material as closely as possible to the offset mold surface. Paths for forming the heating and/or cooling channels (24) could also be generated.

In this embodiment, the tooling plate then would be cut to the envelope dimensions and fixtured on the cutter, for instance the waterjet cutter, and the program would be run. It is expected that, if necessary, cuts of up to 20 cm deep could be made in the tooling plate. In FIG. 5B the waterjet cut surfaces are denoted as surfaces (28). Material (29), in FIG. 5C shows material that, for instance, may be removed in a subsequent finish machining operation. As an example, while there are some limitations to the capabilities of a waterjet cutter (for example, sharp corners along the length of a zone cannot be cut, etc.), it is expected that most waterjet cut surfaces will be within 3 mm or less of the final surface. This is a depth of cut that can easily be accommodated with a finishing tool. In areas of the mold requiring sharp corners additional material removal might be necessary. Thus, in one embodiment of the inventive process, some semi-roughing passes could be programmed into the CNC operation in order to remove this additional amount of material. Alternatively, these passes could also be made with a finishing tool.

Abrasive waterjet cutting is a relatively new and attractive alternative method for cutting a variety of materials. Abrasive waterjets are capable of cutting nearly any material from stone to plastics, metals, composites, and glass. Modern controllers allow waterjet cutters to offer a good degree of accuracy at much higher feed rates than CNC machining or EDM, while waterjet cutting remains less expensive and more versatile than laser or plasma cutting. The benefits of abrasive waterjet cutting make it a very cost-effective solution in many situations traditionally handled by other machines.

An abrasive waterjet cutter uses a highly pressurized stream of water and solid abrasive particulate to cut through materials. Waterjet machines are most commonly 2 or 3-axis machines used to cut plates of material, however, they work equally well in 5 or more axis configurations, as they are capable of cutting through material at angles of over 450. The machine usually consists of a gantry x- and Y-axis positioning system over a large slotted table. Parts sit on the slotted table, and excess water and removed material flows into a bath under the slots. High pressure intensifier pumps supply water pressure to the nozzle of between 350 and 400 MPa and the water is mixed in the nozzle with garnet abrasive particles at a computer controlled rate. The mixing rate of the particulate controls the cutting and maximizes feed speeds.

Waterjet cutting has numerous attractive qualities. Waterjets are capable of accurately cutting nearly any material at thicknesses between 0.025 and 14 cm. Though some accuracy is lost cutting through very thick materials, abrasive waterjets are capable of cutting through 40 cm of steel. The thin, 0.08 to 0.15 cm, kerf width minimizes material waste, and because the cutter can start and stop anywhere on the stock, more parts can be cut from a single block of material than with other processes. Waste is further reduced because the scrap material is easier to recycle in clean slugs rather than coolant soaked chips. Another advantage of water jet cutting is the cold cutting accuracy it produces. Because waterjet cutters do not burn through material in any way, they completely avoid heat-treatment and residual stresses left on the surface of the parts produced by other methods. Heat sensitive materials such as metals and plastics can easily and accurately be cut to within tolerances of 0.13 mm or better. Additionally, there is no flash, burrs, or burnt edges to be post processed.

The waterjet process is capable of cutting reflective and heat sensitive materials that laser and plasma cutting cannot even attempt, and the accuracy is far better than either of these two methods. The feed speed in waterjet cutting is limited by the thickness of the material and the complexity of the path. While most waterjet machines are capable of rapid traverse speeds of over 1.5 m/min most feed rates are between 0.127 cm per min and 1.3 m/min. When competing with electrical discharge machining and traditional CNC cutting, feed rate is a key issue. Waterjet cutters are far faster and more versatile than either of these methods, and provide relatively close tolerances. Additionally, with 5-axis control a waterjet cutter would be capable of cutting nearly any complex shape very closely to its final dimensions in any material.

Because the abrasive component, typically, garnet, is consumed in the process, waterjet cutting is not completely without cost. Operation of a waterjet cutter costs around $100/hr when all costs of worn nozzles, abrasives, and machine operation are taken into account. The cost of waterjet cutting is largely a factor of the amount of abrasive garnet consumed per part, which is proportional to the speed at which the jet is advanced without excessive deflection. It is preferable to produce the zone sections at a reasonable speed and cost, and thus, it is preferable to maximize the cutting speed of the complex curves in the tooling plates. Since almost all abrasive waterjet cutting has been done with a two or three axis table, there is very little data on 5-axis cuts. However, it is known that controlling the tolerances of a complex cut is merely a matter of experimentation with the materials and the curvatures involved. Achieving the necessary speeds for a cost effective part could require the development of a model relating the curvature of a part with the angle of the jet and the thickness of the material at that angle. These relationships would preferably be established for each tooling material under consideration and then integrated into software that could be used to control the machine.

While a waterjet cutter is an extremely powerful tool, it is also a fairly recent innovation. New techniques are constantly being developed to optimize its performance and expand its capabilities. In order to optimize the use an abrasive waterjet for cutting the zone sections out of tool steel, the performance of the equipment would have to be established in advance. Optimal cutting speed is expected to vary with curvature at between 5-20 mm/min in 10 cm thick plate, and thus it would be highly unlikely that an operator could guide the machine through the cutting program manually to prevent gouging. Further, is it expected that optimal feed rates for straight and curved cutter paths will be determined empirically for varying depths of cut in order to properly program the tool path generation software. Unlike milling, there are currently no known effective theoretical models that could be used to accurately predict performance, especially within the tolerances sought for in the process.

In one embodiment of the inventive process, once the performance of the cutting tool has been characterized, the integration of this information into toolpath software macros could be accomplished. In order to minimize the amount of material that is removed in the finish machining operation, it is desired to develop the capability to efficiently guide the jet around the mold contours. For instance, in a 5-axis system, the waterjet could enter and exit the plate at nearly any angle, allowing sculpting of complex curves to flow around part features. Where material cost is a consideration, the core and cavity sections of a mold may be cut from one plate of steel, allowing nesting of the paired zones and minimizing scrap. However, this process, while minimizing material cost, might complicate cutting of the parts because special fixtures and procedures will have to be developed to accommodate this technique.

One method of assuring accuracy in a waterjet cut is to slow down the feed rate, but at 5-20 mm/min the process is already slow and a large number of linear centimeters of cut will have to be made for each zone. However, if the Electron Beam Welding occurs at speeds of 300-400 mm/min (although on four sides instead of one), the waterjet cutting step would be the slowest step of the process, and thus, efforts to optimize this step could be of significant value. By speeding up the feed rate along straight paths and slowing the feed rate around curves, it is expected that the overall efficiency of the waterjet cutting process could easily be doubled.

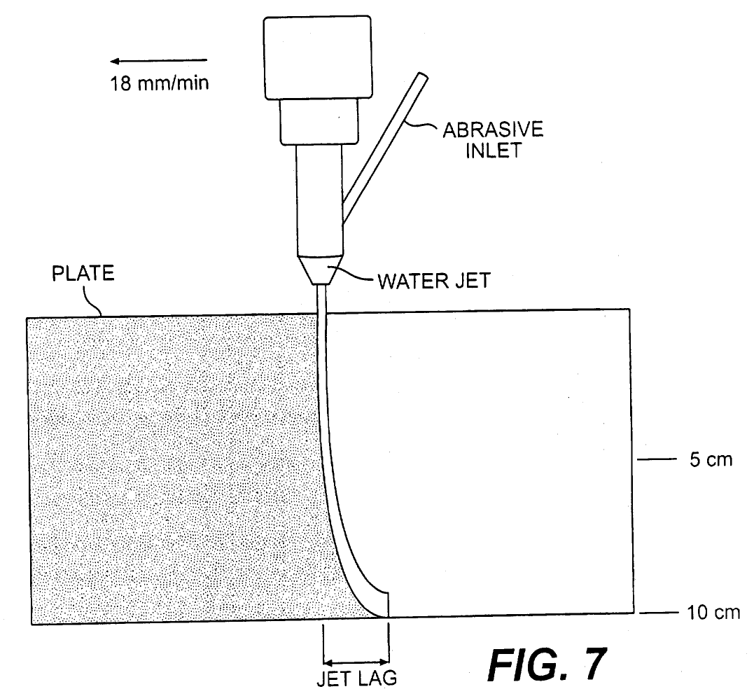

One problem with waterjet cutting is the tendency for the waterjet to deflect, or lag, from its intended path at high feeds through thick materials. This is usually not a problem until the path curves, causing the lagging portion of the jet to cut off of the intended path (See FIG. 7). This phenomenon is similar to the tendency of a heavy milling machine to overshoot its path around tight corners. However, certain software, such as SDRC's I-DEAS Camand Multax software package, contains algorithms for controlling the speed of a tool around a curved path. To input the proper constraints on the waterjet cutter, the deviation of the jet should to be measured across a wide spectrum of variables. The jet performance can be captured in a number of ways. For instance, a plate could be cut at varying speeds along a sinusoidal path, and the resulting part scanned into a coordinate measuring machine (CMM). The cut surface could then be compared in the CAD software to the intended surface and a tolerance specification could be generated. A more detailed picture of the jet path could be obtained by stopping the jet in mid cut and slicing the plate along the kerf line, thus, capturing a path similar to that shown in FIG. 7. By repeating these tests across the range of depths and speeds used in the process, paths could be generated that would result in a known error range.

In one aspect of the invention, in order to speed the overall process of manufacturing a near net-shaped mold, as soon as the cutting program is generated a solid model of the waterjet roughed mold could be sent back to the customer for advance programming of the finish machining process. The expected 0.2 mm accuracy of the waterjet could allow a program to be developed that begins finish machining immediately, without “cutting air” to establish a known mold surface, further reducing machining and programming time.

In a further embodiment of the invention, after the zone sections have been rough cut with the waterjet, they could be aligned and fixtured in preparation for permanent assembly by, for example, electron beam welding (EBW). A program for controlling a 5-axis electron beam EB welder could be generated based on the solid model of the roughed zones. The aligned zone assembly then could be fixtured on a rotary table in an EB chamber. A vacuum could be pulled in the chamber and the assembly welded together at depths of up to 10 cm. In special cases, weld penetration of up to 20 cm is expected to be possible. Chambers of up to 3.5×2.7×2.7 m are available, so virtually any size mold can be accommodated.

Electron beam welding has been around since the 1950s, but the advent of accurate multi-axis computer control has recently allowed the process to perform welds that were previously impossible, and with repeatable quality. Any weld that can be made in the lab can now be duplicated in production. For instance, deep penetration welds, which were problematic in the past, have been used successfully in the new F-22 Advanced Tactical Fighter program. Moreover, the F-22 program is making extensive use of EB welding in major structural areas, including making deep welds in varying thicknesses of titanium along complex curvatures.

Electron beam welding (EBW) is a high energy density fusion process that transfers energy to a joint using an intense beam of electrons. The process was initially applied to industrial processes in the 1950's, and has since matured into an important modern joining technology. In many instances, EBW can produce welds of superior quality and depth than other welding processes, both conventional arc welding and other high energy density fusion processes such as laser welding. Because a highly focused electron beam can concentrate enormous power on a small spot on a workpiece, there is extremely rapid local melting and vaporization at the joint to be welded. The welds produced are usually very deep, narrow, and almost parallel-sided. They have relatively small heat-affected zones, and can usually be produced with a single welding pass. Precise computer numerical control over most aspects of the welding process is possible. In addition to readily joining common metals, the process can also join dissimilar or hard-to-weld materials.

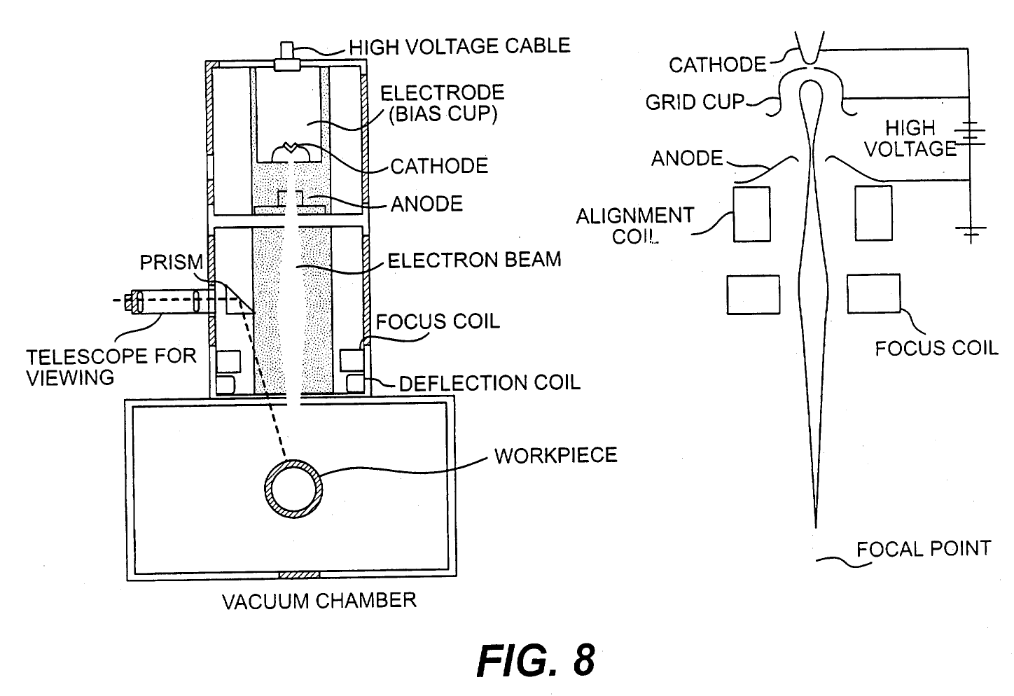

The basic principles behind the creation of an electron beam have been successfully applied for decades. (One of the most common applications of electron beams is the television picture tube.) Most EB welding machines use a triode-style electron gun. The gun consists of a three-electrode assembly that produces and accelerates the electron beam, and electromagnetic coils that focus and deflect it (see FIG. 8). The cathode is a filament heated to about 2500° C. It is made of a high-emission material such as carbon or tungsten and maintained at a large negative potential by a high-voltage source. This hot, charged filament emits electrons. The grid cup, which may also be called a bias cup, is a specially shaped electrode that can be negatively biased with respect to this heated cathode. The grid cup regulates the number of electrons that will form the beam. Changing its potential changes the number of electrons than can accelerate towards the anode, which is at ground potential. The electric field created by the large potential difference accelerates the electrons to up to 70% of light speed and shapes them into a collimated beam. The voltage applied to the electrodes can typically vary from 30 to 200 kV. The beam current can typically range from 0.5 to 1500 mA, and the beam power from 30 kW to 200 kW. The energetic beam passes through an orifice in the anode, and then through an electromagnetic focusing coil. This magnetic lens reduces the diameter of the electron beam, focusing it to a small spot at the workpiece. An electromagnetic alignment coil can be used to deflect the beam through an angle of typically up to 15°.

The electron gun is maintained at a high vacuum (on the order of 13 mPa, or 10⁻⁴ torr) in order to prevent filament oxidation or gun arcing due to the high voltage, and to maintain general gun cleanliness. In order to obtain a small beam spot size and very deep penetration of the part, the work chamber should also be kept at a high vacuum. (Medium- and non-vacuum electron beam welding is suitable for many applications, but any atmosphere in the welding chamber diffuses the electron beam, impeding attainment of truly high energy densities.)

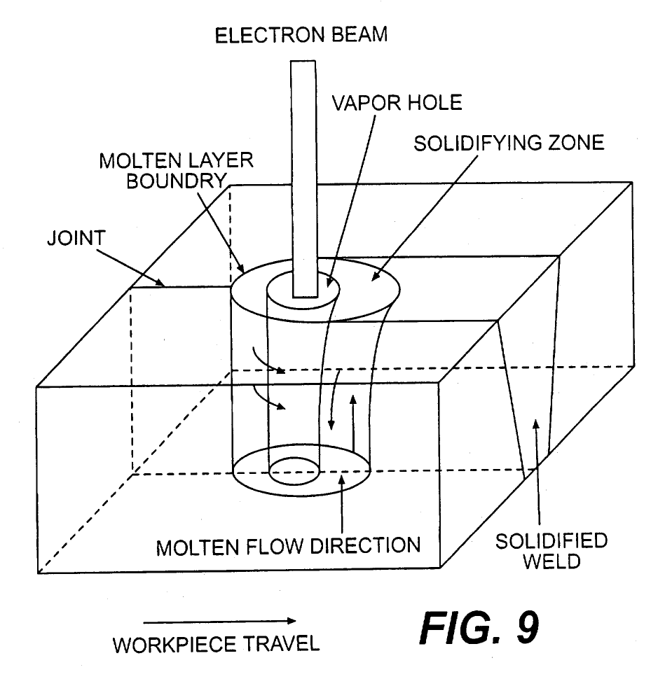

When deep penetration is desired, the focused electron beam can strike the workpiece in a spot as small as 0.25 mm to 1.3 mm wide, applying up to 10⁸ W/cm² at that point. The resulting temperature of about 14,000° C. forms a deep vapor hole. The material at the leading edge of the vapor column melts, with the liquid suspended by vapor pressure. As the workpiece is moved beneath the beam, a weld is formed when the molten material flows around the hole and solidifies after filling the trailing edge. This mode of welding is called the keyhole mode because the shape of the hole and the trailing weld resembles a keyhole (see FIG. 9). The workpiece itself is grounded, so no charge builds up from the constant stream of electrons striking it.

Electron beam welding offers substantial process control. The basic control variables that control the beam intensity and spot size for a given electron gun are:

beam current; electron acceleration voltage;

focusing current, which controls the focal length of the magnetic lens and thus the beam focus location;

standoff, i.e., the distance from the gun to the part; and

welding speed or the speed at which the spot travels on the part.

Increasing the beam power, the product of the beam current and the acceleration voltage, generally increases both the depth of penetration and the melting rate. Increasing the welding speed generally decreases both the depth of penetration and the weld width. Reducing the intensity of the beam spot, such as by defocusing or oscillating the beam, generally decreases the depth of penetration but increases the weld width.

Additionally, the electromagnetic alignment and focusing coils can be manipulated to gain additional control over the welding process. The electromagnetic alignment coil can slightly deflect the beam to change the angle at which the electrons impact the workpiece. This allows certain joints that would be hard to reach with a perpendicular beam to be welded. The alignment coil can also cause the beam to oscillate at greater than 5 kHz, effectively creating a greater beam spot size. This technique can generate wider welds, slower cooling rates, and more uniform weld shapes without having to defocus the beam. It can also control porosity in partial-penetration welds. When maximum penetration is desired, the focusing coil can make the beam spot on the workpiece as small as possible. However, the focusing coil can also defocus the electron beam, spreading out the beam energy over a larger area. This can be done in order to produce a wider weld. Another use of the defocused beam is for heat-treating. A diffuse electron beam may be applied to a workpiece surface, increasing its hardness by about two Rockwell hardness points above other heat-treating methods.

The electron beam could be also be pulsed to reduce the rate of heating without changing any other beam characteristics. Typical frequency ranges are 0.1 Hz to 3 kHz, with pulse durations up to 70 ms. Low frequency pulses could be used to produce tack and spot welds. Pulsation at higher frequencies could offer control over the solidification pattern of the weld and the microstructure of the heat-affected zone. In addition, peak temperatures near the weld location are usually lower, although the total heat input to the part may be higher if a slower welding speed has to be used.

A computer control system could handle almost all aspects of the electron beam welding process, including workpiece movement and variations in beam power, focus, and alignment. Modern control systems for EBW are capable of very high accuracy, flexibility and repeatability. However, there are many potential sources of error, particularly those that affect maintenance of a tight joint-to-beam coincidence. Because of this, a method called “scanning” may be used to check the runout between the beam spot and the joint to be welded. When scanning, a weak beam that has enough power to create a detectable spot, but not enough to overheat the workpiece, is focused on the part surface. The piece is aligned and then taken through a complete cycle as a check.

Electron beam welding can present numerous advantages over other welding processes:

It can produce welds that are deeper and narrower than other processes can. Electron beam welds can be as deep as 150 mm in steel, 305 mm in aluminum, and 100 mm in copper.

The total heat input from EBW may be much lower than that from arc welding. This means that the heat-affected zone on the workpiece is generally narrower than that of arc welding. The lower amount of heat also generally gives rise to fewer thermal effects, including distortion and shrinkage, and allows welding to take place near heat-sensitive components such as sensors.

The high depth-to-width ratio of electron beam welds means there is usually no need for multiple-pass welds, unlike in arc welding.

Welds made in a high vacuum are typically free from impurities like oxides and nitrides.

The high melting rates allow high weld speeds, leading to greater productivity and better energy efficiency. For instance, the total energy efficiency conversion of EBW, at 65%, is typically higher than that of arc welding, and much higher than that of other high energy density processes.

EBW can weld most hardened metals, frequently with no significant deterioration of mechanical properties at the weld. According to the 1993 ASM Handbook, Vol. 6: Welding, Brazing, and Soldering, no annealing or other heat-treating operations are needed for high-speed joining of tool steels.

EBW may also reach otherwise inaccessible joints, including multiple tiers of joints separated by a gap but aligned identically.

A high degree of process control is also possible with EBW. The precision of EBW is inherently high, as is its repeatability.

The finishing and cleaning costs are low.

One disadvantage of EBW is the high capital cost, which is generally higher than the cost of conventional arc welding, although competitive with the cost of other high energy density processes. Another limitation is the need for a high vacuum. The size of the vacuum chamber limits the size of the workpiece, and the time required to pump the chamber down limits production rates. For example, a 0.85 m³ chamber takes about three minutes to pump down. An 8.5 m³ chamber takes about 10 minutes.

As with any welding process, EBW typically causes changes in hardness at the weld and its heat-affected zone. The heat-affected zone width, which is usually proportional to the weld width, also influences shrinkage and distortion. Welding also typically causes residual stresses due to shrinkage of the weld. These effects should, preferably, be minimized.

In addition, the weldability of tool steels varies considerably. Control over accuracy and surface quality depends on control over residual stresses and surface roughness in the finished mold. Control over surface roughness requires control over variations in hardness at the mold surface. Because welding causes changes in the hardness at the weld and surrounding heat-affected zones, it is desiravle to determine what combination of beam characteristics, welding speed and workpiece post-treatments are optimal for welding any particular material. The “Procedure Development and Practice Considerations for Electron Beam Welding” section in the 1993 ASM Handbook. Vol. 6: Welding, Brazing, and Soldering discusses the surface hardness variations encountered when electron beam welding hardenable steels, tool steels, and hardened and work-strengthened metals. Due to the inherently narrow welds and heat-affected zones, and the rapid heating, melting, solidification, and cooling times, base metal properties could be retained even close to the EB weld. It should also be possible to reduce or eliminate any variations by post-weld heat treating the welded sections.

EBW joint strength can approach that of the base metal, without preheating or post-weld treatment other than stress relief. However, it might be desirable to pre-heat or post-heat thicker sections to prevent cracking. When joining tool steels, one advantage of electron beam welding is its ability to weld at high speed without necessitating annealing or other heat-treating operations.

It may be desirable to perform coupon testing on a variety of tool steels in order to develop data on EBW. Ground plates could be fixtured together and welded at depths of up to 90 mm. Any of the computer controlled welding parameters discussed above could be varied in order to improve the process. It is expected that the one problem that will have to be overcome will be the variation in hardness in the heat-affected zone.

It also may be desirable to evaluate the mold quality and optimize the processing parameters by measuring the surface roughness of the mold cavity after machining and the microhardness and microstructure across the welding area. The uniformity of these properties could serve as one criterion to judge the mold quality. It is expected that the welding process will affect these properties and that a heat treatment may be desirable to minimize the welding effects. Surface roughness is closely related to variations in hardness at the surface layer of the mold, and the hardness is in turn determined by the microstructure of the mold material. Since fusion welding can cause microstructure changes in the weld and heat-affected zone, the hardness in this area may differ from the non-welded area, which could then affect the uniformity of the surface roughness when finished. The profiles of the microhardness across the welding area could, preferably, be determined. Moreover, the relationship between the surface roughness, hardness and microstructure could be investigated.

A Vickers microhardness tester could be used to measure the microhardness along the cross section of the EBW samples. The profiles of microhardness then could be used to evaluate the uniformity of the hardness along the cross section of the EBW samples and to determine the width of the weld and heat-affected zone. A uniform profile is usually desirable. Significant variation of the microhardness may suggest that welding has caused serious microstructure changes. In that case, post heat treatment may be desirable to achieve a homogeneous microstructure and recover uniform hardness.

An optical microscope and a scanning electron microscope (SEM) could also be used to observe the microstructure at the welding area. Further information on phase and composition change could be obtained by x-ray diffraction (XRD) and electron probe microanalysis (EPMA). These microstructure analyses could allow determination of the causes of microhardness changes at the welding area, such as phase transition and defects. This information could ultimately indicate ways to optimize the EBW and heat-treatment, including means such as surface cleaning, pre-loading of the workpiece, varying electron beam voltage and/or current, beam focus size, welding speed, and pre or post heat-treatment schedule.

Hardness represents the degree of the plastic flow of a material under a given stress. Three major types of hardness testers are commercially available: Brinell, Rockwell and Vickers. All are based on the same principle: an indenter is impressed on the surface of a specimen with a given force. The hardness is a function of the size of the resulting indentation. The differences between testers are their shapes and the methods used to measure the indentations they make. The Brinell method uses a hardened, 10 mm diameter, steel ball as the indenter and the hardness number (HB) is calculated by dividing the applied load by the surface area of the indentation. The Rockwell method commonly uses a Brale indenter that is a diamond ground to a 120° cone with a spherical apex having a 0.2 mm radius. The Rockwell hardness number is determined by the depth of the indentation made by a constant load impressed on the indenter. The Vickers indenter has a square-based diamond pyramid geometry. The Vickers hardness is measured by the length of the two impression diagonals.

The Brinell hardness test is quite simple, but its steel indenter cannot test very hard materials. The relatively large indentation limits the size and shape of the workpiece and the workpiece usually is not usable after testing. Rockwell hardness testing is the most widely used method for determining hardness. It is convenient to perform and does not require highly skilled operators. By use of different loads and indenters, Rockwell hardness testing can be used for determining the hardness of most metals and alloys, ranging from the softest bearing materials to the hardest steels. It takes just seconds to take a reading, and no optical measurements are required. However, the Rockwell tester lacks a continuous scale. No single scale can cover the full hardness range; different scales have to be selected for specific materials.

While the Brinell and Rockwell testers are used for macrohardness testing due to the size of their indentations, the Vickers hardness testing is usually used for testing microhardness. The Vickers microhardness testing can provide information on the hardness characteristics of materials that can not be obtained with Brinell or Rockwell. Microhardness testing is recognized as a valuable method for measuring hardness of surface layers, bonding layers, coating, foil, wire, small precision workpieces, and areas close to edges. It is especially useful for determining the hardness profile on the welding cross sections of test pieces. The hardness profile provides direct evidence about the uniformity and quality of the welding area. This may predict the surface roughness of the welded pieces after finishing. However, optical equipment is used in microhardness testers for accurate measurement of the indentation diagonals. Special training is needed for operators to prepare and test specimens.

The total profile of a part's surface has two major components: roughness and waviness. Waviness is a long-wavelength condition, which is typically influenced by such factors as the condition of the machine tool's spindle bearings and vibration from other sources on the shop floor. Roughness—a shorter-wavelength pattern of irregularities that is overlaid on top of the waviness pattern—is the pattern of tool marks on the part. Both components may be influenced by the machine operator's choice of feeds and speeds.

By evaluating the roughness, microhardness, and microstructure of each test weld, an evaluation of the effectiveness of the many possible beam settings may be possible. The process could continue in a feedback loop until the desired properties are achieved for each tool material. For example, a coupon test on P-20 tool steel might progress as follows:

initial electron beam settings and path speeds are chosen based on initial material knowledge;

a coupon is welded at these settings, or a range of one parameter could be welded in one test;

the coupon is machined and polished to simulate the finishing process;

surface roughness is evaluated and compared to accepted limits for mold manufacture;

hardness across the weld area is examined;

investigation of the microsructure is made with the techniques described above;

by relating features in the microstructure to their known effects on roughness and hardness, a plan for modifying the microstructure to a more favorable arrangement is made;

one or more of the many parameters under control in the EBW process are altered to produce the desired effect; and

the process is repeated until satisfactory results are achieved.

Achieving acceptable welds may be even more complicated when multiple plates and welds are involved because of the cumulative effect of shrinkage and residual stresses.

In one aspect of the present invention, which takes advantage of the narrow weld heat-affected zone, strain gauges and other sensors could be placed in the tool between the plates, thereby allowing a direct measurement of the stress or other properties in the assembly. Moreover, as quality control procedures become more widely adopted by molding companies, the need for various sensors in the mold increases. By machining pockets or drilling holes into selected zones, any of a wide variety of sensors, such as pressure sensors, thermocouples, or strain gauges, could be placed anywhere in the mold. The computer model of the mold and/or the computer model of the mold filling and curing operations could be used to determine which sensors are appropriate and where they should be placed.

The effects of preheating, tack welding, weld order, welding speed, cooling rates, and preload could also be evaluated, for instance, by scanning the molds, or prototype molds, with a Hewlett Packard Laser Coordinate Measuring Machine or other similar coordinate measuring machine (CMM). CMM's allow a very accurate comparison of the dimensions and shape of the tool both before and after welding or other machine operation. The accumulation of errors from multiple fixturing, aligning, and welding operations and the effect on joint location and part accuracy could also be determined, as could thermal expansion of the part during welding, which might affect the location of unwelded joints. Based on this information, the variables for modifying the properties of the welded assembly could be restricted to the range that was established in the coupon testing to produce satisfactory properties.

According to the present invention, alternative methods may also be used to permanently assemble the zone sections after they have been rough cut and aligned. For example, as described below, brazing and diffusion bonding (either diffusion brazing or diffusion welding) are viable alternative assemble methods.

Brazing is a process for joining solid metals in close proximity by introducing a liquid metal that melts above 450° C. (840° F.). A sound brazed joint generally results when an appropriate filler alloy is selected, the parent metals are clean and remain clean during heating to the flow temperature of the brazing alloy, and a suitable joint design that allows capillary action is used. Strong, uniform, leak-proof joints could be made rapidly, inexpensively, and even simultaneously. Metal as thin as 0.01 mm (0.0004″) and as thick as 150 mm (6″) can typically be brazed. Moreover, brazed joint strength generally is high. A simple joint could have strength equal to or greater than that of the as-brazed parent metal.

One attractive feature of brazing is that brazing does not involve any substantial melting of the base metals. This offers several advantages over other welding processes. It is possible to maintain closer assembly tolerance and to produce a cosmetically neater joint without costly secondary operations. Brazing also makes it possible to join dissimilar metals, metals to ceramics, or ma terials that cannot be joined by traditional fusion processes.

Brazing also produces less thermally induced distortion or warping than fusion welding. An entire part can be brought up to the same brazing temperature, thereby preventing the kind of localized heating that causes distortion in welding.

One drawback to brazing is that brazing produces a heat affected zone (HAZ) with a strongly altered microstructure due to intensive mutual mass transfer between the base metal and the filler metal. The width of the HAZ varies with the heating processes used. As a rule, the HAZ produced during brazing is wider and less sharply defined than those resulting from other fusion-related processes.

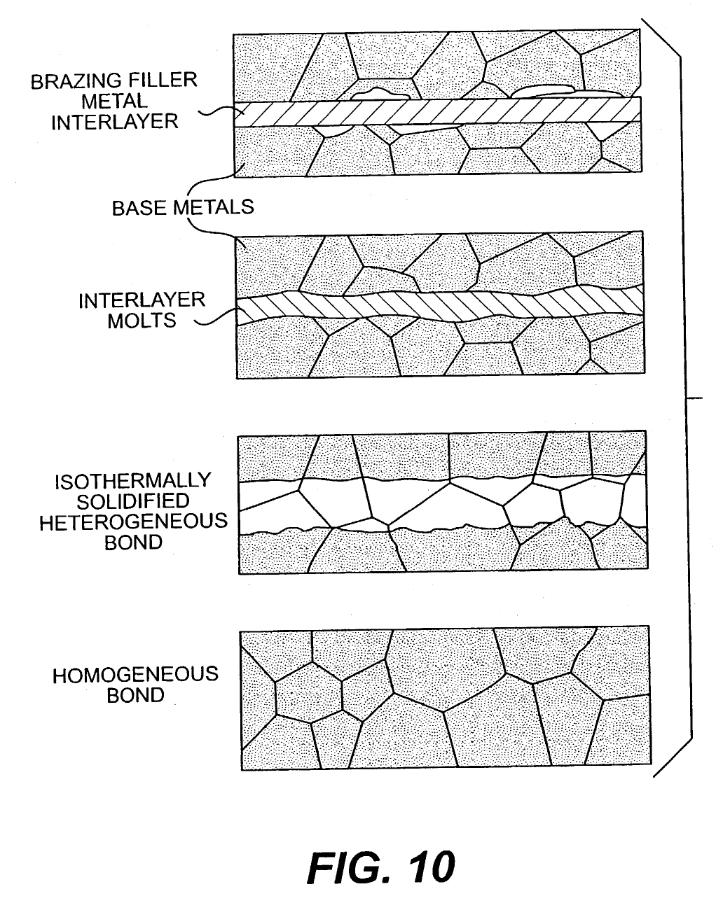

In another embodiment of the inventive process, diffusion bonding is another method that may be used to permanently assemble the zone sections. Diffusion bonding can refer to either diffusion brazing or diffusion welding, depending on whether a filler metal is used. Diffusion brazing is a process that joins metals by heating them to a suitable brazing temperature at which either pre-placed filler metal will melt and flow by capillary action or a liquid phase will form in situ between one faying surface and another. In either case, the filler metal diffuses into the base metal until the physical and mechanical properties of the joint become almost identical to those of the base metal. (See FIG. 10.) Pressure may be applied to bring the metal up to the brazing temperature. Diffusion brazing involves two aspects. First, just like the usual brazing process, liquid filler metal must be formed and become active in the joint area. Second, the filler metal must extensively diffuse into the base metal. This diffusion process often eliminates the identity of the original brazed joint.

The amount of diffusion that occurs typically depends on the brazing temperature and time, the quantity of filler metal available for diffusion and the mutual solubility of the filler metal and the base metal. Diffusion brazing is commonly performed in furnaces specifically set aside for brazing or heat-treating. It is possible to initially braze two parts together by induction heating or by torch brazing, and then place the brazement into a furnace for the extended diffusion cycle. This cycle typically ranges from 30 minutes to 80 hours, or even longer. When a brazement is to be made using either a pre-placed sheet of filler metal or a layer of filler metal powder, pressure is normally applied to the assembly to reduce the gap between the two base metals when the filler metal becomes molten.

Some of the most advanced diffusion brazing processes are used in the aerospace industry, particularly for brazement involving titanium, nickel, cobalt, and aluminum alloys. As an example of these processes, a cobalt-base alloy was diffusion brazed at 1120° C. (2050° F.) in a vacuum furnace using a nickel-chromium-boron filler material in sheet form. The assembly was held at temperature for 8 hour. Even though the solidus of the filler metal alloy was only 970C (1780° F.), the braze joint completely lost its identity through diffusion, and the resulting remelt temperature was above 1370C (2500° F.). In this case, pressure was applied by simple weights on top of the part. Because the filler metal alloy contained boron as a melting point depressant, the diffusion of the boron out of the filler metal into the base metal caused the remelt temperature of the filler metal to rise. Because boron is also a very small atom, it very easily diffuses away from the joint as the temperature of the base metal rise.

Diffusion welding is another alternative method for permanently assembly the zone sections. Diffusion welding is an elevated-temperature, solid state joining process. A monolithic joint is formed by bonds at the atomic level, which arise from diffusion at the mating surface layers. In its simplest form, diffusion welding may include holding pre-machined and cleaned parts in intimate contact and then heating them in a protective atmosphere. Diffusion plays a major role in joining the mating parts. High temperature and pressure may cause microscopic (local) plastic deformation and aid the inter-diffusion between the mating surfaces of the parts, but the macroscopic plastic deformation can be minimized. To ensure sufficient atomic mobility while minimizing macroscopic plastic deformation, an appropriate balance between the process variables of temperature, pressure and time must be established.

Conventional diffusion welding typically uses uniaxial loading, which can be applied by dead weight, mechanical, pneumatic, or hydraulic means. The applied loading is generally limited by the allowed macro-deformation of the parent material. Temperature usually ranges from 50 to 75% of the melting point. Heat can be applied by radiant, induction, or resistance heating. Time may vary from several minutes to several hours, depending on the pressure and temperature used. Most diffusion welding operations are performed in vacuum or inert gas to prevent metal oxidation and maintain a clean weld interface. Pre-machined parts should have a surface finish of better than 0.4 μm (16 μin.), roughness average (RA). The surface should be swabbed with acetone or petroleum ether immediately before the set-up in the welding machine. Ultrasonic cleaning can also be used. Ion bombardment or other means are also sometimes used to remove the oxide at the surface of the parts.

Hot isostatic pressing (HIP) diffusion welding involves the application of a high-temperature, high-pressure gas to components. The pressures with HIP diffusion welding are typically significantly higher than those used in the uniaxial welding. However, because the pressure is isostatic, the level of deformation is extremely low. In addition, less pre-machining is normally required. Isostatic pressurization could allow the welding of more complex geometry than a uniaxial welding process could handle.

A hot isostatic press consists of a furnace within a gas pressure vessel. Its size can range from a diameter of 100 mm (4 in.) to a diameter of 1.1 m (44 in.) and a height of 2.2 m (88 in.). Argon gas is typically used, and there is a need to encapsulate the bond interfaces to prevent the gas from entering the site of the bond. This is most often achieved by locating the parts in an evacuated and sealed steel can. Typical HIP cycles can last from 6 to 16 hours, or longer. The minimum pressure and temperature desired for the HIP welding depend on the metals and alloys. The temperature is generally 50-70% of their melting point. The pressure is limited to around 25 MPa for most metallic systems for economic reason although higher pressure may be applied.

One advantage of diffusion bonding is that the joint line disappears completely and the whole component becomes a homogeneous unit. However, diffusion bonding usually requires that all parts be heated to an elevated temperature in one furnace. Although essentially no melting of the base metal occurs, the temperature involved can affect the properties of the metal being joined. For example, cold worked base metals may soften or undergo grain growth because the diffusion bonding temperature may be above their recrystallization temperature. The heat required for diffusion bonding may also alter mechanical properties obtained by heat treatment. Therefore, diffusion bonding should only be used in certain specific cases. For instance, materials in the annealed condition are usually not altered by diffusion bonding, or materials could be heat-treated again after diffusion bonding to recover their original properties.

In one aspect of the inventive process, after welding, the mold could be heat-treated and stress relieved in a normal manner. Any heating and/or cooling channels could be smoothed and deflashed with, for example, abrasive flow machining (AFM,) as discussed below.

In another aspect of the inventive process, the conformal heating and/or cooling channels (24) could preferably be waterjet cut from the zones (22) before welding (See FIG. 5B). This could give rise to sharp angles or even small steps at the zone boundaries, as well as possible welding flash. Conventional machining methods probably could not be used to remove the steps and flash due to the expected contoured, conformal nature of the channels. One solution to this issue is the application of Abrasive Flow Machining (AFM) technology. AFM could involve forcing polymer borne abrasives, for instance, through the heating and/or cooling channels to remove any steps and flash, as well as polish the inside surfaces of the channels. A dilatant version of the polymer could be formulated to undergo shear-thickening, thereby allowing the removal of more material as resistance to the polymer flow is increased. This could result in more material being removed from large steps and less material being removed from smoother areas. One abrasive flow machine typically contains two vertically opposed media cylinders hydraulically closed to hold the part between them. By extruding the abrasive media from one media cylinder to the other, a honing action is produced wherever the media enters and passes through a restrictive passage. By cycling the media through the channels in both directions, the steps and flash could be eliminated or reduced. This would allow for proper flow of the heating and/or cooling fluid through the mold. Even if the channels could be finish machined, AFM porting of the heating and/or cooling channels could conceivably easily be achieved in a matter of minutes and might be significantly faster than other alternative machining operations.

One challenge to commercially applying AFM to molds manufactured by the inventive process lies in developing an attachment system that would allow the mold to be connected to the AFM equipment by hoses or hard lines. This would eliminate the need to mount the molds between the media cylinders.

In one embodiment of the inventive process, the manufacture of a near net-shape mold could be concluded by cleaning and performing minor machining to ensure proper alignment on the customer's milling machine of the welded assembly. Fittings could be added to the heating and/or cooling channels.

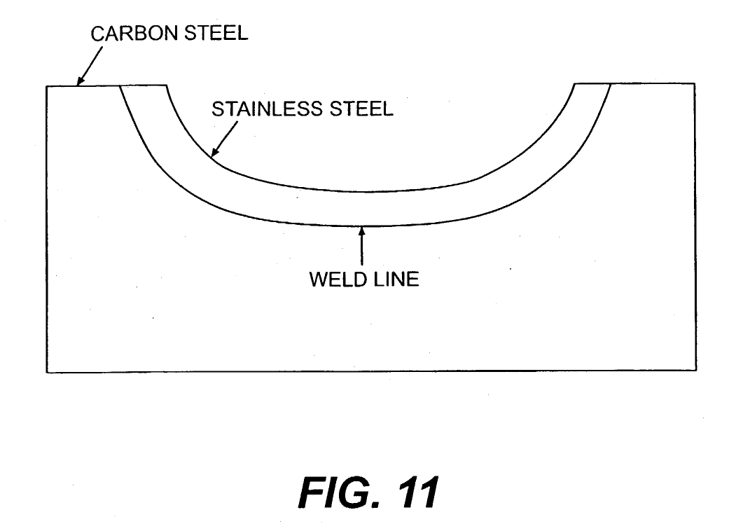

Another embodiment of the invention process could involve the creation of individual zone plates that are made up of two or more materials. These subzones of different materials could be welded together to create the final zone. An example would be a mold that is constructed with stainless steel core and cavity surfaces that are reinforced or backed with a less expensive material such as carbon steel. The stainless steel subzones could be waterjet cut to match the part contours and to provide the desired depth from the mold surface. The carbon steel subzones could be cut to match the inside surface of the stainless steel subzones. The individual subzones could be finished machined for a close fit and then electron beam welded, or otherwise assembled, together into a zone (See FIG. 11). The weld flash could be ground off, and then the assembled zones could be assembled into the near net-shape molds as described above.

In addition to being used for direct mold production or for producing preforms, the inventive process could also fully support other popular large mold production techniques. For instance, molds made using NVD or electroplated nickel shells are in common use in the automotive and consumer products sectors, where the tremendous size of some of the molds makes handling a solid steel block inconvenient. In these processes, the inventive technique could also provide tremendous cost and lead time savings. The first step in the production of a shell mold (typically nickel), as discussed above, is the manufacture of a pattern, which is usually machined from aluminum (for ease of fabrication) or stainless steel (if several molds must be made from one pattern). A large aluminum pattern is usually cast to near net-shape and then finish machined With the high material cost of aluminum, the material savings advantage of casting usually outweighs the long lead time. Using the inventive process, a pattern preform could be produced in a small fraction of the time it takes to commission a casting. Moreover, it is expected that such a pattern preform would not suffer from problems with porosity. Additionally, more machinable grades of aluminum could be used with the inventive process, as the properties of rolled plate far exceed those of a casting.

Once the pattern is finished and the shell (42) is produced, it must be backed up with some kind of support structure or mold backing (See FIG. 6). On a large mold, this backing must be extremely strong and fit perfectly with the shell. The usual process is to cut nickel or stainless steel plates to match the contours of the shell and then weld them in place in an egg crate structure. An alternative process is to backfill the shell with a polymer concrete formulated to match the coefficient of thermal expansion (CTE) of nickel. Both techniques have serious drawbacks. Welding of the thin shell will always create some warpage and stress, regardless of how much care is taken in the process. A polymer backfill generally has poor thermal properties, and can separate from the shell over time.

Using one embodiment of the inventive process, a mold backing (40) could be easily fabricated to a near net-shape, needing little or no finish machining. The material for the mold backing could be, for instance, nickel or copper, or a combination of both. One advantage of the shell (42) if it is made of nickel, is its higher thermal conductivity over tool steel and the ability to weld or braze copper heating or cooling tubes directly onto the shell. The mold backing manufactured according to the present invention could provide an even better arrangement. By using copper plates for the backup structure and cutting conformal lines throughout, the entire surface of the nickel shell could be placed in contact with the copper of the mold backing, resulting in a perfectly even surface temperature having the highest possible conductivity. The shell and the mold backing could be made of any suitable material and are not limited to nickel and copper.

Alternatively, the near net-shape of the mold backing using the inventive process might not match the surface of the shell exactly, so an intermediate layer (44) could be employed (as shown in FIG. 6). For instance, the CTE of copper is only slightly higher than that of nickel, minimizing the potential for problems. Moreover, thermal stresses could be reduced or eliminated in the composite mold by choosing an appropriate material for any intermediate or transition layer. This intermediate layer should ideally have a CTE higher than the shell, but lower than the mold backing (for this example, higher than nickel and lower than copper). It is expected, for instance, that a ceramic and metal (cermet) cement having such a CTE could be formulated. Possibly, this cement could be a mixture of copper powder and ceramic binder such as silica sol or phosphate. Since the ceramic usually has a CTE around 8×10⁻⁶ mm/mm/C, adding the proper amount of copper powder should produce a cement with a CTE between nickel and copper. The cement could be applied between the shell and the mold backing. To make a removable shell, a separation agent could be sprayed on the surface of the mold backing before the cement is applied. The shell and the mold backing would then be held in place until the cement cures. An additional advantage of any such copper cermet would be its high coefficient of thermal conductivity.

The purpose of any cermet transition layer (44) is to join the shell (42) and mold backing (40) together and, in the process, fill any gap between them. This gap preferably should be eliminated because it blocks heat transfer and might cause the shell to deform in the gap area due to lack of support from the mold backing A cermet material is expected to have the appropriate properties to provide an effective solution to these problems.

A cermet is a mixture of one or more ceramic materials with a metallic phase. Cermets typically combine the toughness of the metal with the thermal resistance and hardness of the ceramic. Cermets are usually formed by mixing, pressing and sintering. They are used in rocket motors, gas turbines, turbojet engines, nuclear reactors, brake linings, cutting tools, etc. As the transition layer between the shell and mold backing, the cermet should ideally have the following characteristics:

matching coefficient of thermal expansion (CTE);

high thermal conductivity;

high compression strength; and

easy processing.

Matching CTE is could be important for a mold to avoid thermal damage such as cracking. For example, a nickel shell with a CTE of 13.5×10⁻⁶ mm/mm/C is a fairly close match to a copper mold backing with a CTE of 17×10⁻⁶ mm/mm/C. The amount of thermally induced stress could be further reduced if the cermet transition layer is formulated with a CTE between these two values. The exact cermet might not be available commercially, but it could conceivably be readily fabricated from the combination of several existing materials. For example, for the composite mold with nickel shell and copper mold backing, the cermet used for the transition layer could be a mixture of copper powder and ceramic binder such as silica sol, water-soluble silicate or phosphate. Since the ceramic usually has a CTE around 8×10⁻⁶ mm/mm/C, adding the proper amount of copper powder might produce a cermet with a CTE between nickel and copper. Moreover, the addition of copper powder could substantially increase the thermal conductivity of the cermet, while the ceramic binder could produce very high compressive strength, depending on processing. The processing of the cermet could be as simple as conventional slip casting. Therefore, a cermet made from copper powder and ceramic binders might satisfy all of the major requirements for the transition layer between a nickel shell and a copper mold backing.

The processing of the cermet usually involves several steps: determining ingredients, mixing, curing, measuring the rheological properties such as viscosity of the cermet slip (or slurry), and measuring the thermal properties, such as CTE and conductivity, of the cermet after curing. The processing equipment would most likely include a mixer, a balance, a viscometer and some containers. The cermet slip could be sprayed or brushed onto the surface of the mold backing to form a gel coating. The shell could then be pressed on tightly until the cermet cures. To make a removable shell, a separation agent could be sprayed on the surface of the mold backing before the cermet is applied. It also might be preferable to formulate the cermet for room temperature curing.

Cermet transition layers can be formulated for optimum physical and thermal properties. Particle size and filler-to binder ratio have a great influence on the final properties, including shrinkage, resistance to thermal shock, bond strength, porosity, and thermal conductivity. One property for slips is thixotropy. Although many slips are thixotropic, they typically process well with mixing because slight agitation causes the material to flow. Spraying or brushing the slip onto a vertical surface also breaks down its thixotropic structure, thereby allowing the slip to be spread thinly and easily. However, once applied to the mold backing, it is generally desirable that the slip recovers its gel structure as fast as possible to prevent the slip layer from sagging off the surface.

Proper dispersion of the slip is another parameter in slip preparation. Wet ball milling or mixing is the most common technique. The ingredients, including the powder, binders, wetting agents, sintering aids, and dispersion agents, are typically added to the mill with the proper proportion of the selected casting liquid and milled to achieve thorough mixing, wetting, and particle reduction. The slip is then allowed to age until its characteristics are relatively constant. It is then ready for final viscosity checking (and adjustment if necessary), de-airing, and application.

For one aspect of the present inventive process, it is desirable that the cermet also serve as an adhesive material to bond the nickel shell and copper mold backing together at room temperature. Water-soluble silicate, silica sol, and phosphate are commonly used adhesive materials that can be cured at room temperature.

Water-soluble silicates are usually the alkali-silicates such as sodium, potassium and lithium. The water-soluble silicate coatings could be applied by spraying, brushing, or dipping. They can be cured at room temperature or at temperatures ranging from 90 to 320° C. (200 to 600° F.), and they can be chemically bonded to metal substrate. These water-soluble silicate coatings are tough, withstand limited deformation of the substrate, are resistant to shock and fatigue, and provide protection against oxidation in air at temperature up to 1370° C. (2500° F.). Because of their chemically combined water content, coatings must be dried carefully to prevent separation from the substrate by blistering, cracking, or peeling.

The soluble silicates may be reacted with silicofluorides or silica to produce acid resistant cements. These products typically have low shrinkage properties and a thermal expansion close to that of steel. Compressive strengths approach 50 MPa but the strength is lost at 400° C. Sodium silicate, commonly known as water-glass, is a colorless low cost inorganic material and is usually supplied as a viscous water solution. The composition is normally expressed in terms of the ratio SiO₂: Na₂O and usually varies from 2 to 3.5 with a viscosity suitable for most commercial bonding formulations. This adhesive material displays little tack and positioning pressure must be applied to hold substrates together until the bond is sufficiently dry. The dry adhesive is brittle and water sensitive and the glue-line may be dissolved out by water until atmospheric carbon dioxide forms an insoluble material.

Silica sol is basically a water-based colloidal silica solution. It has similar properties to the soluble silicate, but has better thermal stability because it contains no portion of Na₂O. The silica sol as a binder is very strong, depending on the curing conditions. Net or near net components can be made with the silica-sol-bonded powder. For example, the silica sol Ludox® from DuPont Company is widely used as a binder for precision ceramic shell molding in the steel casting industry. The relatively thin mold shells can withstand the molten steel without collapsing.

Phosphates are formed by the chemical reaction of phosphoric acid and a metal oxide such as aluminum oxide, chromium oxide, zinc oxide, or zirconium oxide. Phosphate-bonded coatings have low density, low thermal conductivity, and high refractoriness after curing at temperatures ranging from 2 to 430° C. (70 to 800° F.). Zinc phosphate is widely used as dental cement. This material is also modified with silicates to produce the so-called ‘permanent materials’ used for filling. Compressive strength up to 200 MPa is typical of these materials.

After preparation, the phosphate slip is typically aged for 24 hours or more to permit reaction between the acid and the metal oxide. The aged slip could then be troweled directly onto the substrate. The coating is preferably cured while closely controlling time and temperature. The reaction between the acidic coating and the substrate may cause bloating or blistering upon deposition or after initial curing as the result of the release of the hydrogen from the acid. The volatilization of phosphorus pentoxide (P₂O₅), a decomposition product of the acid, could also cause blistering. Various compounds such as chromic oxide, ammonia compounds or ferric phosphate could be added to the coating materials to prevent phosphorus pentoxide from corroding the substrate. These additives generally increase the pH of the coating without affecting the bonding action.

Copper powder is commercially available and has the preferred high thermal conductivity. A fine powder is preferred, typically ˜325 mesh. For higher strength requirements, an even finer powder (averaging less than 5 μm, with a substantial portion under 1 μm) could be used. Particle size distribution should yield maximum packing and uniformity during casting. To withstand cyclic thermal shock, a bimodal particle size with some particles considerably larger than 325 mesh could also be used. Particle sizing is often combined in one step with the addition of binders, wetting agents, deflocculants, and densification aids and also with slip preparation. This is usually done by ball milling, but could also be done by vibratory milling or other processes that provide wet milling. After milling, the slip could be screened. Slight adjustment might be required to achieve the desired viscosity and then the slip would be ready for aging, de-airing, spraying or brushing.

As discussed above, it is preferred that the cermet slip or slurry be thixotropic for easy spraying and long storage life. The viscosity of the cermet could be measured by a simple cup style orifice viscometer. The ideal range of the viscosity could be determined by spreading tests performed on actual molds. Alternatively, the viscosity of the cermet could be measured with the more accurate rotational viscometer, which could also provide data for accurate quality control of the cermet slip process.

The CTE and conductivity of the cermet after curing are also properties to control. In order to measure these properties, the cermet slip could be cast into plaster molds to form specimens for thermal testing. The CTE values of the cermet could be measured by a dilatometer. The thermal conductivity of the cermets could be measured by a calorimeter.

The inventive process is a novel and unique approach to producing a mold. In one embodiment, instead of turning the roughed volume of the mold (including any drilled heating and/or cooling channels) into metal chips, this material would be removed much more efficiently with an abrasive waterjet. Accessing the material may be accomplished by sectioning the mold into predetermined zones, which could then be put together with an electron beam welder. The combination of these complex tasks with advanced software tools to manage the process has the capability to yield a process that is far more sophisticated, capable, and innovative than the standard approaches it replaces. Moreover, the inventive process is compatible with conventional machining, HVM, and nickel tool approaches to the manufacture of large molds.

As described above, the inventive process preferably combines three primary state-of-the-art technologies: 5-axis abrasive waterjet cutting, electron beam welding, and knowledge-based computer aided design. The designing of the mold, the selection of the zones, and the control of the cutter and welder are preferably to be automated as much as possible. Such automated programs will preferably be packaged into a CAD system in the form of automated macros for the sectioning of the mold, optimally locating the heating and/or cooling channels, and programming the machines. Ideally, materials selection tools will contain the knowledge base necessary for the unique weld settings required by different tooling metals.

In a preferred embodiment, the models developed for the EB welding and waterjet cutting are integrated into a unified design tool. One program that may be used to facilitate this integration and the development of a unified design tool is SDRC's Open I-DEAS architecture. The I-DEAS system was initially chosen because all of the design tools and functions are available, and any custom features which are needed can be seamlessly integrated into the I-DEAS development environment. In addition, SDRC's Camand Multax seems to be the most capable 5-axis toolpath generation software available (it is the software of choice for HVM), with all of the required functionality already built into the software. Material specific models will preferably be integrated into the design software and user interface. Moreover, other software systems may also be used without departing from the scope of the inventive process.

One known CAD/CAM software package is based on SDRC's I-DEAS platform. This interactive package could greatly reduce the engineering time and effort needed to design and section the mold for construction. The software would ideally walk the user through the placement of conformal heating and/or cooling channels, parting lines, and mold surface cutting paths. Integrated performance models could aid in the analysis of everything from heat transfer rates to stresses at the heating and/or cooling channels, and could allow the user to automatically place features on the mold without a lengthy design process. Additionally, the flexibility of Open I-DEAS could allow all possible steps in the design to be integrated into one package. This complete design tool could enable the user to create a finished, sectioned mold from a simple CAD model in a matter of hours or days.

The following is an example of an interactive software package that may be developed using existing software development tools. For instance, SDRC's I-DEAS Master Modeler™ is a first class solid modeling package that could easily be linked to SDRC's Camand Multax for 5-axis toolpath generation. I-DEAS is also designed to link to other CAD software packages such as ANSYS and to a variety of other applications such as databases or spreadsheets. The I-DEAS Master Modeler, itself, allows the user to design precise details about geometry, topology, form features, design history, variational dimensions, geometric constraints, engineering equations, surface finish, performance characteristics, advanced kinematics, dimensional and form tolerances, design rules, application knowledge, assemblies, drawings, simulation results, machining parameters, NC toolpaths, assembly sequences, and more. Due to its depth of application integration, I-DEAS Master Series facilitates one's ability to create, simulate, optimize, document, build, and test a design in a single environment.

When linked to Camand Multax, Master Modeler becomes even more powerful. Camand Multax, a 5-axis path generation software, allows control over all of the variables in toolpath generation. The user is able to establish independent engineering equations to control paths, feed rates, tool accelerations, and depth of cut. The software allows the user to handle curves and difficult to machine features with the same ease as straight cuts. Because of its capabilities and flexibility, Camand Multax is able to create complex toolpaths for a 5-axis water jet cutter.

Open I-DEAS also allows a programmer low-level access to all of the standard functions in 1-DEAS. This gives a second party developer the power to write macros for I-DEAS. These macros could, for instance, access other programs just as I-DEAS can, which gives the end user a powerful, multi-functional CAD tool. A user-developed macro could, for example, provide a user interface that incorporates solid modeling, finite element analysis, mathematical calculations, and a variety of other tools for part design. Toolpaths for manufacture of a part could be generated from the same macro using Camand Multax, so that the user need not transfer the finished part to another software suite for toolpath generation. In essence, a single program could handle all of the steps in the design process right up to manufacture.

The Open I-DEAS software has already proven effective in applications with user requirements similar to those in the inventive process. In fact, SDRC offers a number of optional software packages designed in Open I-DEAS for specific applications. These applications include simulation of cables, part assemblies, fluid flow in molds, manufacturing processes, and a host of other specific simulations that a particular customer may or may not need. One particularly relevant application product that SDRC offers is I-DEAS Sheet Metal Design™. This package was created in Open I-DEAS to aid in the design, layout, and manufacture of sheet metal parts.

The Sheet Metal Design software automatically incorporates user-defined bend tables, stress reliefs, and shrinkage allowance into solid models in order to rapidly design and evaluate sheet metal parts. A “Dynamic Navigator” guides the user through geometry and constraint creation, and gives the user a wide variety of choices in part design. For example, the user can choose to model the part by defining common bend lines and joining 2-dimensional sections. Alternately, the user could extrude open sections that the program will then intelligently bend so that interpanel relationships are automatically inherited. Material bend tables allow the user to quickly select the appropriate bend allowances for a particular material and thickness. Similarly, other design parameters are easily calculated using other macros designed specifically for the manufacture of sheet metal parts. This type of interaction between “smart” software and user is desirable in order to streamline the design process.

As mentioned, the software associated with certain embodiments of the current inventive process could aid the user in design of the mold and generation of the cutting paths, for instance, for the 5-axis water jet cutter. As an example, the first step in the design could be to import the model of the mold into I-DEAS. Typically a customer would supply a solid model file for the mold to be produced. A CAD model in any solid modeling format could be easily translated into I-DEAS. Once the model is in the Master Modeler, the mold designer could, for instance, initiate a macro for developing the conformal heating and/or cooling channel design.

The heating and/or cooling channel design macro could, for instance, prompt the user for the desired thermal qualities, mold stiffness, and any special heating and/or cooling channel constraints imposed by the desired part manufacture system. The software could then automatically create an optimal heating and/or cooling channel design using theoretically and empirically derived equations and links to optimization software, such as ANSYS. Once the software has had a chance to offer a design, the user could be given a chance to modify any equations or dimensions as necessary. This capability is standard in I-DEAS, and with a few modifications would produce a flexible tool for design and evaluation of the heating and/or cooling channel design. Furthermore, the software could, for instance, display the results of a thermal finite element analysis (FEA) of the part for immediate inspection, as well as a stress analysis of the mold under simulated loading in the press. The heating and/or cooling channel design macro could produce a design quickly and effectively for simple molds with minimal work from the user. For more complex molds, the user could have the flexibility to check the design and make changes as necessary because all of the analysis tools would be already incorporated into the software. Further, the macro could add optimal features to the design where appropriate. For example, the heating and/or cooling channels could be designed for maximum surface area, turbulent flow, and conformance to the surface of the mold to promote better cooling.

After the heating and/or cooling channels have been added to the mold design, the user might move on to a sectioning macro. This macro could, for instance, aid the user in placement of the parting lines for the mold. The user could determine along which axis the mold will be sectioned and could be prompted for either the number of sections or a standard section width. Of course, using ground plates of specific dimensions will impose some constraints on the placement of these sections, so the user could have a “snap” function which would allow the user to place parting lines only where appropriate. Also, the user could define the height of the plates to be used (for instance, requiring that they be taller than any mold features), and this height could be stored for later use in path generation. The user could then add, move, or remove sections to better accommodate the features of the mold. For example, a particular feature might be placed within one section to simplify the cutter path generation.

After the mold has been analytically sectioned, a surface could be created that can be cut by a cutter, for instance a waterjet, and leave a safe amount of material to be finish machined later. Each plate will naturally have curves on each of its two faces at the intersections of both the mold surface and conformal channels. While the mold surface may have some detail, it is preferable that the cutter macro will not generate section surfaces that would remove any features. Software could be used to detect any areas where these features would potentially be cut off and the splines could be adjusted to add a safe amount of material to these features as well. As with the other possible macros, the user could be given an opportunity to visually check the paths to ensure that the proper amount of material is slated to be removed from each zone plate.

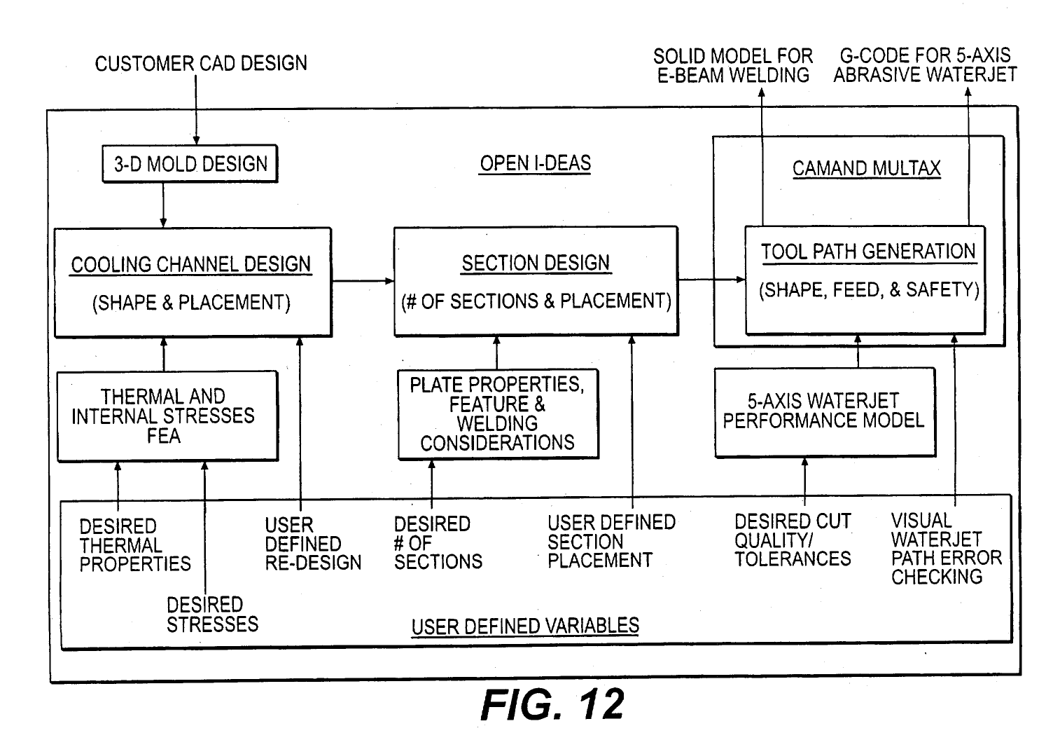

Once the section shape is finalized, I-DEAS Master Modeler could then, for instance, pass the mold section geometry to Camand Multax, or other suitable software, for toolpath generation. This software would generate the machine control code to cut the sections. This data on the behavior of a cutter at different feed rates, thicknesses, and angles in different materials could be used by Camand to simulate the cutter and adjust the feed rates to produce superior cut quality even on complex curves. Again, the user would preferably be able to visually check the cutting procedure in simulation before exporting the code to the cutter. A typical flowchart, which is not meant to be limiting, for the process is shown in FIG. 12.

The inventive process is not limited to molds or mold backings. For instance, the inventive process could be used to manufacture sheet metal stamping dies. Moreover, although it is expected that the inventive process will be most commercially feasible when applied to large items, e.g. large molds, large mold backings, or large stamping dies, the inventive process is not inherently so limited.

Even other embodiments of the invention will be apparent to those skilled in the art from consideration of the specification and practice of the invention disclosed herein. It is intended that the specification and examples be considered as exemplary only, with a true scope and spirit of the invention to be indicated by the claims.

What I claim is:

1. A method for manufacturing a near net-shape part from a plate material, comprising the steps of:
cuffing the plate material into a plurality of zones, each zone having a length, a width, and a depth;
machining a surface profile at least partially into the depth and at least partially across the width of at least one of the plurality of zones;
assembling the plurality of zones by placing the zones side-by-side; and
fastening the plurality of zones together.

2. The method of claim 1, wherein the step of fastening includes electron beam welding.

3. The method of claim 2, wherein at least a portion of the weld formed by the electron beam welding penetrates approximately to a depth of 100 mm.

4. The method of claim 1, wherein the step of machining includes machining a channel through the width of each of more than one of the plurality of zones, and the step of assembling includes aligning the channels of adjacent zones.

5. The method of claim 1, further including, after the step of fastening, the step of deflashing the channel by forcing an abrasive-filled fluid through the channel.

6. The method of claim 1, wherein the step of machining includes using an abrasive waterjet cutter.

7. The method of claim 6, wherein the step of machining includes machining a surface profile into each of more than one of the plurality of zones.

8. The method of claim 7, wherein the surface profiles differ from one another.

9. A method for manufacturing a near net-shape part from a plate material, comprising the steps of:
creating a computer model of a part;
analytically sectioning the computer model of the part into a plurality of part zones;
generating at least one part zone cutting path for a first cutting machine to follow;
cutting the plate material into the plurality of part zones, each part zone having a length, a width, and a depth;
generating at least one surface profile cutting path for a second cutting machine to follow;
machining at least one surface profile at least partially into the depth and at least partially across the width of at least one of the plurality of part zones;
assembling the plurality of part zones by placing the part zones side-by-side;
generating at least one welding path for a welding machine to follow; and
fastening the plurality of part zones together.

10. The method of claim 9, wherein the step of creating includes designing channels into the computer model of the part.

11. The method of claim 10, wherein a heat transfer analysis is used to aid in the design of the channels.

12. The method of claim 9, further including the step of generating channel cutting paths for a third cutting machine to follow, and the step of machining includes machining a channel through the width of each of more than one of the plurality of part zones, and the step of assembling includes aligning the channels of adjacent part zones.

13. The method of claim 9, wherein the first cutting machine and the second cutting machine are the same machine.

14. A method for manufacturing a near net-shape mold portion from a plurality of weldable material pieces, comprising:
machining a first surface profile into one of the plurality of weldable material pieces and a second surface profile into a second of the plurality of weldable material pieces; and
after machining, electron beam welding the plurality of weldable material pieces together.

15. The method of claim 14, including creating the plurality of weldable material pieces by cutting a weldable material.

16. A mold portion manufactured from at least two mold portion zones electron beam welded together using the method of claim 14.

17. A method for manufacturing a near net-shape mold portion from at least one material, comprising:
creating a computer model of a mold portion;
analytically sectioning the computer model of the mold portion into a plurality of mold portion zones;
analytically generating at least one surface profiling path; and
analytically generating at least one fastening path.

18. The method of claim 17, including;
assembling a plurality of mold portion zones composed of the at least one material;
machining at least one surface profile into at least one of the plurality of mold portion zones following the analytically generated at least one surface profiling path;
fastening at least two of the plurality of mold portion zones together following the analytically generated at least one fastening path.

19. The method of claim 18, wherein the at least two of the plurality of mold portion zones are electron beam welded together.

20. The method of claim 18, wherein the at least two of the plurality of mold portion zones are brazed together.

21. The method of claim 18, wherein the at least two of the plurality of mold portion zones are diffusion bonded together.

22. The method of claim 18, including
analytically generating at least one mold portion zone cutting path for a cutting machine to follow; and
cutting the at least one material into at least one of the plurality of mold portion zones following the analytically generated at least one mold portion zone cutting path.

23. The method of claim 18, wherein each of the plurality of mold portion zones has a depth and a width, and the at least one surface profile is machined at least partially into the depth and at least partially across the width of at least one of the plurality of mold portion zones.

24. The method of claim 18, wherein more than one surface profiling path is analytically generated and each of the more than one surface profiling paths is machined into at least one of the plurality of mold portion zones.

25. A mold portion manufactured from at least two mold portion zones electron beam welded together using the method of claim 19.
